(19) United States
(12) Patent Application Publication
(10) Pub. No.: US 2009/0319421 A1
(43) Pub. Date: Dec. 24, 2009

(54) Method and Apparatus for Performing Financial Transactions

(76) Inventors: Kenneth A. Mathis, New Canaan, CT (US); Patricia E. Messina, New York, NY (US)

Correspondence Address: DIEHL SERVILLA LLC, 77 BRANT AVE, SUITE 210, CLARK, NJ, 07066, US

(21) Appl. No.: 12/121,989

(22) Filed: May 16, 2008

Related U.S. Application Data
(60) Provisional application No. 60/976,917, filed on Oct. 2, 2007.
(60) Provisional application No. 61/053,445, filed on May 15, 2008.

(51) Int. Cl. G06Q 40/00

(52) U.S. Cl. 705/40

(57) ABSTRACT

A system for processing invoices using a network and involving a vendor, a payer, a partner bank, a payer bank and a vendor bank is disclosed. A unique code assigned to records related to an invoice is also disclosed. The system contains a profile of participants. The system also applies engines that facilitate processing of invoice transactions and that can assist in providing notifications of changed status. Messages that may be used in the system for processing an invoice are also provided.

### CROSS-REFERENCE TO RELATED APPLICATIONS

This application claims the benefit of U.S. Provisional Patent Application No. 60/976,917, filed Oct. 2, 2007, which is incorporated herein by reference. This application also claims the benefit of U.S. Provisional Patent Application No. 61/053,445, filed May 15, 2008, which is also incorporated herein by reference.

### BACKGROUND OF THE INVENTION

Embodiments of the present invention generally relate to methods and apparatus for performing financial transactions. More in particular they relate to methods and apparatus for processing of invoices and electronic payment of invoices.

Electronic payment refers to money or scrip, which is exchanged electronically. Typically, this involves use of computer networks, the Internet and digital stored value systems. Electronic Funds Transfer (EFT) and direct deposit are examples of electronic money. Also, EFT is a collective term for financial cryptography and technologies enabling money or funds transfer by electronic means. Worldwide, electronic payments have become a major tool for conducting business.

Enterprise Resource Planning (ERP) is an integrated information system that serves many departments within an enterprise. ERP is usually a packaged software, rather than proprietary software, written by or for one customer. ERP modules may be able to interface with an organization's own software and may be alterable. Therefore, an ERP system can include software for manufacturing, order entry, accounts receivable and payable, general ledger, purchasing, warehousing, transportation and human resources. Examples of ERP vendors are SAP, PeopleSoft, Oracle, Baan and J. D. Edwards. Lawson Software.

Despite the cross-functional and enterprise wide use of ERP and the extensive use of EFT, today, there is very little integration among electronic payments, paper and electronic based remittance information, and ERP accounting systems. Therefore, despite the use of ERP, users are still in need of maintaining a transaction paper mail that corresponds with an electronic payment/financial transaction.

Currently many computer based payment systems, be it with or without integration with ERP, use message formats that are unique to a system or a network or even to specific users. Accordingly, users of disparate payment systems are often required to provide additional information or provide existing information in a new format when they want to perform a transaction with another system. This is a burden on rapid or automatic processing of a transaction.

An additional limitation of current payment systems is that they often require providing data which by some users may be considered confidential and some users are hesitant to provide such details, and decline to use a system that requires such information.

Another additional limitation of current systems is that they are only operational during business hours.

Another additional limitation of current systems is that they have no capabilities for easily resolving exceptions or disputes in transactions.

Another additional limitation of current systems is that they do not provide real-time insight into the status of transactions being processed.

Another additional limitation of current systems is that they have no capabilities for providing advance notice of payments being made.

Another additional limitation of current systems is that they have no capabilities for optimized scheduling of payments.

Another additional limitation of current systems is that they may require extensive integration efforts with existing ERP systems.

Accordingly, novel and improved methods and apparatus for performing financial transactions are required.

### SUMMARY OF THE INVENTION

In accordance with one aspect of the present invention a system is provided which processes an invoice from issuance to receipt of payment and related transactions.

In accordance with a further aspect of the present invention, a system and methods are provided that transmit and collect authorized remittance information related to an invoice from initial issuance of the invoice until payment and receipt of payment.

In accordance with another aspect of the present invention, a system and methods are provided that are designed for an open user group, as means and methods are provided to accept and translate any invoice, message and transaction format that can be translated.

In accordance with a further aspect of the present invention, the system and methods are flexible as they provide on-demand invoice processing, if required per invoice and an outsourced service of invoice processing as it may handle all or a significant part of a vendor's invoice processing.

In accordance with another aspect of the present invention, a system and methods are provided which allow a vendor and a payer to maintain existing banking relations.

In accordance with another aspect of the present invention, an invoice payment system for processing an invoice to effect payment thereof is provided, comprising a controller system, a vendor entity processing system, a payer processing system, a vendor bank, a payer bank, a partner bank, and wherein the controller system communicates electronically with the vendor processing system, the payer processing systems and the partner bank to effect transfer of an amount of money related to the invoice from the payer bank to the vendor bank.

In accordance with a further aspect of the present invention, an invoice payment system is provided, wherein the controller system assigns a unique identifier to the invoice and associates the unique identifier with a plurality of transactions related to the invoice.

In accordance with a further aspect of the present invention, an invoice payment system is provided, wherein the controller system associates the unique identifier to one or more messages related to the invoice processed by the controller system and exchanged with one or more of the group consisting of the vendor entity processing system, the payer processing system, and the partner bank.

In accordance with a further aspect of the present invention, an invoice payment system is provided, wherein the invoice payment system is connected to a network.

In accordance with a further aspect of the present invention, an invoice payment system is provided, further comprising the instructions for transmitting the invoice from the vendor entity processing system to the controller system, associating of a unique identifier to the invoice by the controller system, and generating by the controller system of a message related to the invoice for the payer entity processing system.

In accordance with a further aspect of the present invention, an invoice payment system is provided, further comprising an instruction for generating by the payer entity processing system of a message for the controller system containing an instruction for the payer bank to pay an amount of money related to the invoice to the partner bank.

In accordance with a further aspect of the present invention, an invoice payment system is provided, further comprising an instruction for generating by the controller system of a message for the partner bank containing the instruction for the payer bank to pay an amount of money related to the invoice to the partner bank.

In accordance with a further aspect of the present invention, an invoice payment system is provided, further comprising an instruction for generating by the partner bank a message for the payer bank containing the instruction for the payer bank to pay an amount of money related to the invoice to the partner bank.

In accordance with a further aspect of the present invention, n an invoice payment system is provided, further comprising an instruction for transferring by the payer bank an amount of money related to the invoice to the partner bank.

In accordance with a further aspect of the present invention, an invoice payment system is provided, further comprising an instruction for sending by the payer bank a message to the partner bank confirming transferring of an amount of money related to the invoice.

In accordance with a further aspect of the present invention, an invoice payment system is provided, further comprising an instruction for transferring by the partner bank to the vendor bank an amount of money related to the invoice.

In accordance with a further aspect of the present invention, an invoice payment system is provided, further comprising an instruction for sending by the partner bank a message to the controller system related to transferring an amount of money related to the invoice to the vendor bank.

In accordance with a further aspect of the present invention, an invoice payment system is provided, further comprising an instruction for sending by the controller system to the vendor entity processing system a message related to transferring an amount of money related to the invoice to the vendor bank.

In accordance with a further aspect of the present invention, an invoice payment system is provided, further comprising an instruction for sending a message to the vendor entity processing system expressing an intention to pay an amount of money related to the invoice.

In accordance with another aspect of the present invention, a method for processing of an invoice to effect payment thereof is provided, comprising using a controller system, the controller system enabled to exchange messages related to the invoice with a vendor entity processing system, a payer processing system, a partner bank, the partner bank enabled to exchange a message with a payer bank and a vendor bank, associating a unique identifier with the invoice and associating the unique identifier with a message related to the invoice, and transferring an amount of money related to the invoice from the payer bank to the vendor bank as a result of the exchange of messages related to the invoice.

In accordance with a further aspect of the present invention, a method for processing an invoice is provided, wherein the controller system associates the unique reference number with a plurality of transactions related to the invoice.

In accordance with a further aspect of the present invention, a method for processing an invoice is provided, further comprising the steps of transmitting a message related to the invoice from the vendor entity processing system to the controller system, transmitting by the invoice processing system a message for the payer entity processing system related to the invoice, transmitting by the payer entity processing system a message to the controller system, the message containing an instruction for the payer bank to pay an amount of money related to the invoice to the partner bank.

In accordance with a further aspect of the present invention, a method for processing an invoice is provided, further comprising a step of transmitting by the controller system a message to the partner bank containing an instruction for the payer bank to pay an amount of money related to the invoice to the partner bank.

In accordance with a further aspect of the present invention, a method for processing an invoice is provided, further comprising a step of transmitting by the partner bank a message to the payer bank containing an instruction for the payer bank to pay an amount of money related to the invoice to the partner bank.

In accordance with a further aspect of the present invention, a method for processing an invoice is provided, further comprising the steps of transferring by the payer bank an amount of money related to the invoice to the partner bank; transferring by the partner bank to the vendor bank an amount of money related to the invoice, and sending by the partner bank to the controller system a message related to the transferring of money to the vendor bank related to the invoice.

In accordance with a further aspect of the present invention, a method for processing an invoice is provided, further comprising a step of sending by the controller system to the vendor entity processing system a message related to the transferring of money related to the invoice to the vendor bank.

In accordance with a further aspect of the present invention, a method for processing an invoice is provided, further comprising using a profile unit, the profile unit comprising a profile of a payer.

In accordance with a further aspect of the present invention, a method for processing an invoice is provided, comprising using a visibility engine, the visibility engine providing a report on a status of processing the invoice.

In accordance with a further aspect of the present invention, a method for processing an invoice is provided, comprising using a forecasting engine for forecasting a cash flow status related to a payment of the invoice.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of one embodiment of a financial system that operates in accordance with various embodiments of the present invention;

FIG. 2 depicts an account receivable flow diagram of one embodiment of a method of operating the financial system in FIG. 1;

FIG. 3 depicts an account payable flow diagram of one embodiment of a method of operation of the financial system in FIG. 1;

FIG. 4 depicts a flow diagram of one embodiment of a method of operation between the controller and the partner bank of FIG. 1;

FIG. 5 is another block diagram of the system in accordance with an aspect of the present invention;

FIG. 6 is a diagram of the invoice payment system in accordance with an aspect of the present invention;

FIG. 7 is a diagram of a screen provided by the invoice payment system in accordance with an aspect of the present invention;

FIG. 8 is another diagram of a screen provided by the invoice payment system in accordance with an aspect of the present invention;

FIG. 9 is an illustrative example of a invoice search request;

FIG. 10 is an illustrative example of a dashboard;

FIG. 11 is another illustrative example of a dashboard;

FIG. 12 is yet another example of a dashboard;

FIG. 13 illustrates a series of steps provided by a system in accordance with an aspect of the present invention;

FIG. 14 illustrates a series of analyses that can be performed by a stem in accordance with an aspect of the present invention; and

FIGS. 15-35 show illustrative examples of user interfaces in accordance with one or more aspects of the present invention.

### DETAILED DESCRIPTION

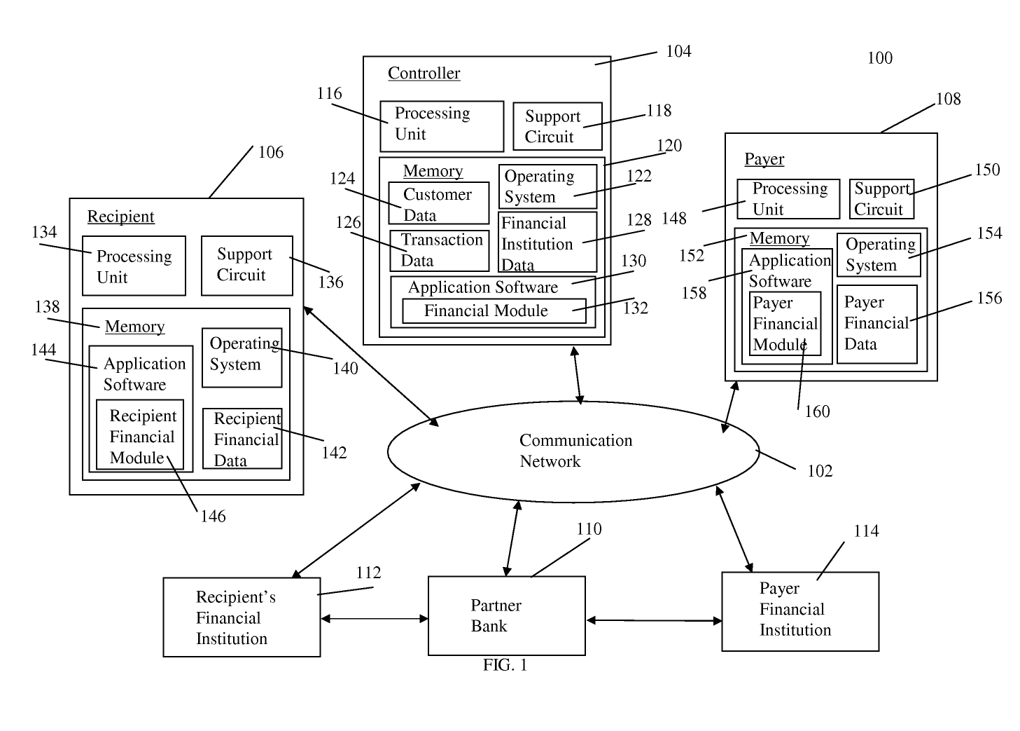

FIG. 1 is a block diagram of one embodiment of a financial system 100 that operates in accordance with various embodiments of the present invention. This figure only portrays one variation of a myriad of possible system configurations. The present invention can function in a variety of computing environments; such as, a distributed computer system, a centralized computer system, a stand alone computer system, or the like. One skilled in the art will appreciate that the system 100 may or may not contain all the components described below.

The financial transaction processing system 100 comprises at least one communication network 102, at least one controller 104, at least one recipient 106, at least one partner bank 110, at least one recipient financial institution 112, and at least one payer's financial institutions 114. The controller 104, the recipient 106, the payer 108, the partner bank 110, the recipient's financial institute 112, and the payer's financial institute 114 are coupled to the communication network 102, which may be a physical link, a wireless link, a combination there of, or the like. The controller 104, the recipient 106, the payer 108, and the partner bank 110 may or may not be in the same location and/or may or may not utilize common system or platforms. For example, the payment request and/or financial transaction may occur outside the existing payments networks, such as, SWIFT, ACH, and other available payment networks.

The controller 104 facilitates financial transaction between the recipient 106, the payer 108, and/or the partner bank 110. The controller 104 comprises at least one processing unit 116, support circuits 118, and memory 120. The processing unit 116 may comprise one or more conventionally available microprocessors or microcontrollers. The support circuits 118 are well known circuits used to promote functionality of the processing unit 116. Such circuits include, but are not limited to, a cache, power supplies, clock circuits, input/output (I/O) circuits and the like. The memory 120 may comprise random access memory, read only memory, removable disk memory, flash memory, and various combinations of these types of memory.

The memory 120 is sometimes referred to as main memory and may, in part, be used as cache memory or buffer memory. The memory 120 stores an operating system 122, a customer data 124, financial institution data 128, transaction data 126, and application software 130. The operating system 122 may be one of a number of commercially available operating systems such as, but not limited to, SOLARIS from SUN Microsystems, Inc., AIX from IBM Inc., HP-UX from Hewlett Packard Corporation, LINUX from Red Hat Software, Windows 2000 from Microsoft Corporation and the like. The application software 130 includes a financial module.

The financial module 132 is utilized by the controller to process financial transaction requests from the recipient 106 and/or the payer 108. The financial module 132 supports the controller in providing a straight-through processing of remittance information with an electronic payment and integration with ERP/accounting systems. The financial module 132 may also facilitate communication between the controller 104 and the partner bank 110. The financial module 132 may contain functionality, such as, cash management, account receivable, account payable, website services, ecommerce support and the like.

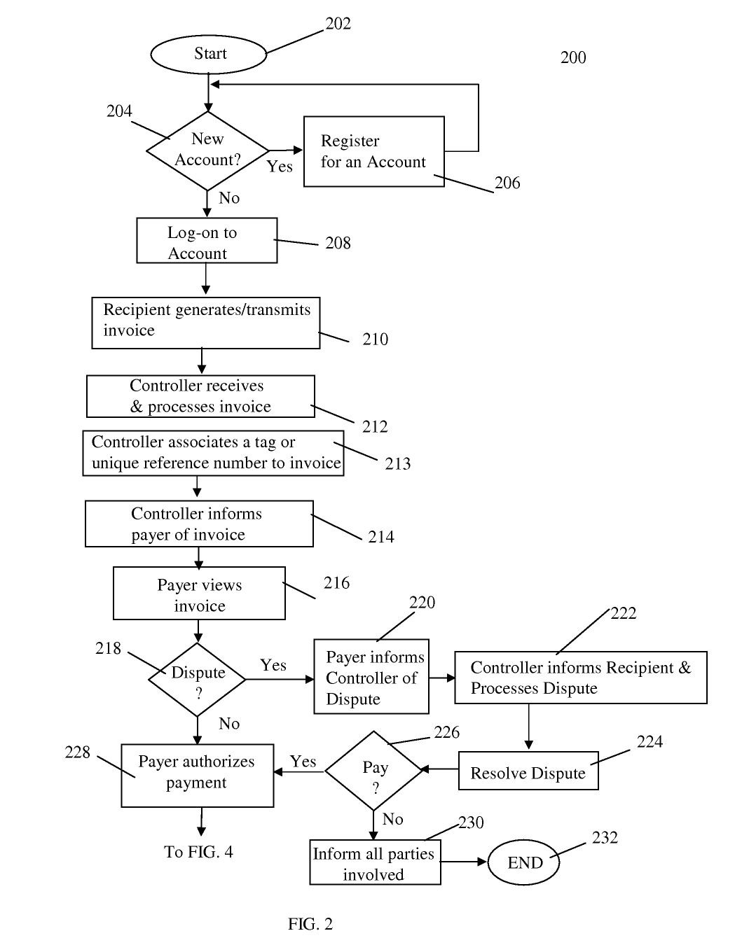

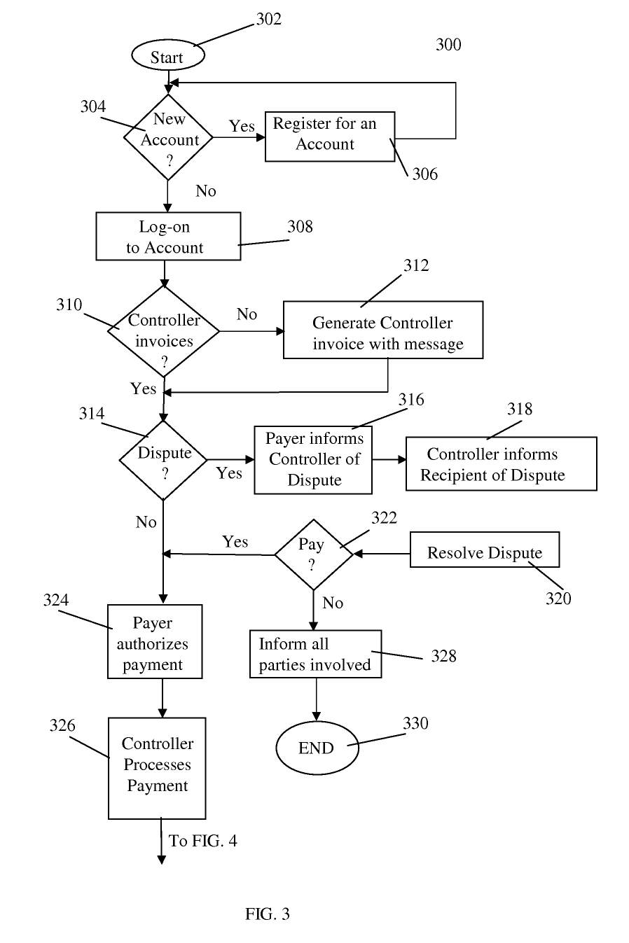

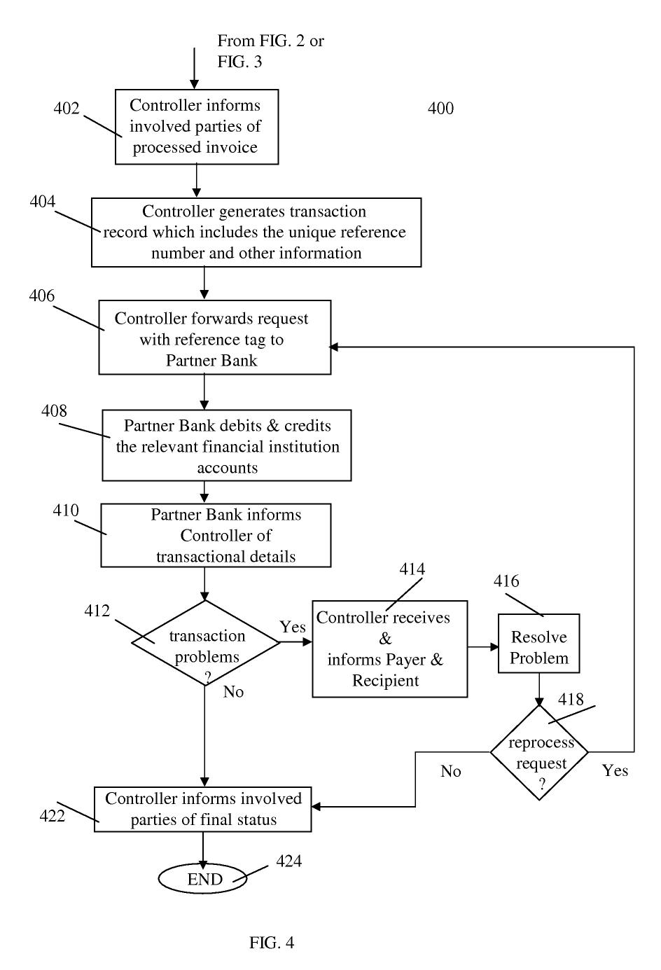

The customer data 124 and the financial institution data 128 include any data that the financial module 132 may utilize. The customer data 124 and/or the financial institution data 128 may include name, address, contact information, account information, identification, password, historical transactions, statistics and the like. The customer data 124 and/or the financial institution data 128 may be accumulated via the recipient 106, the payer 108, the partner bank 110, the user of the controller 104, external sources and the like. The transaction data 126 may include any data generated during a transaction by the recipient 106, the payer 108, generated by the financial module 132, external sources and the like. The transaction data 126 may relate to financial transactions that are being processed and/or that need to be processed by the financial module 132. The transaction data 126 may relate to data in the customer data 124, financial institution data 128, data utilized by the financial module 132 and the like. An embodiment of the utilization of the financial module 132 is described in FIGS. 2, 3, and 4.

The recipient 106 comprises at least one processing unit 134, support circuits 136, and memory 138. The processing unit 134 comprises one or more conventionally available microprocessors or microcontrollers. The support circuits 136 are well known circuits used to promote functionality of the processing unit 134. Such circuits include, but are not limited to, a cache, power supplies, clock circuits, input/output (I/O) circuits and the like. The memory 138 comprises random access memory, read only memory, removable disk memory, flash memory, and various combinations of these types of memory.

The memory 138 is sometimes referred to as main memory and may, in part, be used as cache memory or buffer memory. The memory 138 stores an operating system 140, recipient financial data 142, and application software 144. The operating system 140 may be one of a number of commercially available operating systems such as, but not limited to, SOLARIS from SUN Microsystems, Inc., AIX from IBM Inc., HP-UX from Hewlett Packard Corporation, LINUX from Red Hat Software, Windows 2000 from Microsoft Corporation and the like.

The application software 144 includes a recipient financial module 146. The recipient financial module 146 may be utilized by the recipient 106 to communicate with the controller 104 for viewing and/or performing financial transactions. The recipient financial module 146 may utilize, add or edit the data in the recipient financial data 142, the customer data 124, and/or the transaction data 126 and the like. An embodiment of a method of utilizing the recipient financial module 146 is described in FIG. 2.

In one embodiment, the recipient 106 may not include memory 138. In such an embodiment, the recipient 106 would generate/process financial transactions that the controller 104 would receive and process. The recipient 106 may utilize devices, such as, but not limited to, a computer system, stand alone device, a landline, a mobile phone and the like. The recipient 106 may manually and/or automatically generate/process the financial transaction.

The payer 108 comprises at least one processing unit 148, support circuits 150, and memory 152. The processing unit 148 may comprise one or more conventionally available microprocessors or microcontrollers. The support circuits 150 are well known circuits used to promote functionality of the processing unit 148. Such circuits include, but are not limited to, a cache, power supplies, clock circuits, input/output (I/O) circuits and the like. The memory 152 may comprise random access memory, read only memory, removable disk memory, flash memory, and various combinations of these types of memory.

The memory 152 is sometimes referred to as main memory and may, in part, be used as cache memory or buffer memory. The memory 152 stores an operating system 154, recipient financial data 156, and application software 158. The operating system 154 may be one of a number of commercially available operating systems such as, but not limited to, SOLARIS from SUN Microsystems, Inc., AIX from IBM Inc., HP-UX from Hewlett Packard Corporation, LINUX from Red Hat Software, Windows 2000 from Microsoft Corporation and the like.

The application software 158 includes a payer financial module 160. The payer financial module 160 may be utilized by the payer 108 to communicate with the controller 104 for viewing and/or performing financial transactions. The payer financial module 160 may utilize, add or edit the data in the payer financial data 156, the customer data 124, the transaction data 126 and the like. An embodiment of a method of utilizing the payer financial module 160 is described in FIG. 3.

In one embodiment, the payer 108 may not include memory 152. In such an embodiment, the payer 108 would generate/process financial transactions that the controller 104 would receive and process. The payer 108 may utilize devices, such as, but not limited to, a computer system, stand alone device, a landline, a mobile phone and the like. The payer 108 may manually and/or automatically generate/process the financial transaction.

It should be noted that the financial module 132, recipient financial module 146 and/or payer financial module 160 may or may not be the same module or have similar functionality.

The controller 104 submits financial transaction requests to the partner bank 110. The financial transaction requests may be initiated by the controller 104, the recipient 106 and/or the payer 108. The partner bank 110 forwards the financial transaction requests to the appropriate financial institution, such as, recipient financial institution 112 and/or payer financial institution 114. In one embodiment, the partner bank 110 communicates with the financial institutions, such as, recipient financial institution 112 and/or payer's financial institution 114, via the communication network 102. An embodiment of a method of transaction between the controller 104 and the partner bank 110 is described in FIG. 4.

The controller 104 may communicate with at least one partner bank 110. In one embodiment, the controller 104 may communicate directly with multiple financial institutions, such as, recipient financial institutions 112 and payer financial institutions 114. The partner bank 110 may be in the same location as the controller 104 or in a different location communicating with one another via the communication network 102. In one embodiment, some or all of the functions performed by the controller 104 may be included within and performed by an institution, such as a bank, including the partner bank 110, and/or the functionality of the partner bank 110 may be included in the controller 104.

FIG. 2 depicts an account receivable flow diagram of one embodiment of a method 200 of operating the financial system in FIG. 1. The method 200 starts at step 202 and proceeds to step 204. If the recipient does not have an account, the method 200 proceeds from step 204 to step 206. At step 206, the recipient registers for an account. The account may generate customer information on the controller. If the recipient has an account, the method 200 proceeds to step 208. At step 208, the recipient logs-on to the account.

At step 210, the recipient generates and/or transmits at least one invoice. The recipient may input any invoice into the controller. The controller 104 attaches a unique identifier to each invoice. Such a unique identifier may be a number comprised of a series of digits. It may also include letters. It may also include other symbols. The unique identifier can preferably be coded into a string of binary symbols that can be stored, searched upon, retrieved and processed by a computer device. During further processing, the controller will associate each record and/or transaction related to an invoice which will be handled, processed or stored with the unique reference number of the invoice. Each message or record that will leave the controller 104 is thus associated with a unique reference number. Any message, record or response entering the controller 104 is again associated by the controller 104 with the unique reference number of an invoice. The controller 104 thus associates an electronic tag or reference number to the invoice. The electronic tag or reference number may define one or more transaction details, such as, the kind of products or services that initiated the invoice, parties' agreement details and the like. The unique tag or reference number may also be a unique identifier and files, records and messages associated with the unique tag or reference number may provide information about the invoice. As such, the invoice, which may include an electronic tag or reference number provided by the controller, may allow the involved parties to generate an electronic tracking mechanism. The electronic tracking mechanism replaces the need for paper tracking.

At step 212, the controller receives and/or processes the invoice. The controller may generate a standard invoice. The invoice triggers a financial transaction. The financial transaction will be associated with the unique reference number that will also be associated with relevant financial transactions, such as, transaction processing, transaction requests, transaction messages, transaction disputes and the like, as well as with messages related to the invoice.

The controller attaches or associates an invoice with a unique tag or reference number at step 213.

At step 214, the controller informs the payer of the invoice. At step 216, the payer views the invoice. An electronic message may be entered by the payer or payer system and may assist the payer in documenting relevant events and substitutes the need for paper tracking. The controller 104 will associate any message related to the invoice going to or coming from the payer or the payer system with the unique reference number. Messages received from the payer related to invoice will also be associated with the unique identifier.

In accordance with a further aspect of the present invention, the payer signs on to an interactive computer screen related to an invoice. Any transaction, which may include a payment confirmation, a rejection or a dispute or any other transaction related to the invoice that is performed through the interactive screen will be associated with the unique identifier and stored in a memory or a storage facility that can be accessed by the controller 104. It is to be understood that an interactive screen is any display that may provide information and that reflects information that is provided by a user or a computer. A screen may thus be a computer screen, or any other visual display. However, it may also be a tactile interface or an audio interface or an electronic interface between a computing mechanism and a user. A user may be a human user. A user may also be a system. For instance, payments may be done by a payment system that communicates with the controller 104.

The intention of the invoice system and methods provided herein as an aspect of the present invention are intended to automate and facilitate the processing and payment of invoices. While human interaction with the system is specifically enabled, in one embodiment payment of an invoice takes place substantially without human interaction or interference. To differentiate between roles in a system for instance the terms vendor and payer are used. Also, the institutional terms payer bank, partner bank and vendor bank are used. Each party participating in the payment or processing of an invoice may be represented by a human processing partially or entirely a transaction in a manual way. In one embodiment all parties involved in processing an invoice are computing devices that can process a transaction substantially without human interference. Thus, herein a party such as a payer may be a human but may also be a process system involving a computing device. The same applies herein for all other parties involved in processing of an invoice, including but not limited to a vendor, a partner bank, a payer bank and a vendor bank.

The unique reference number related to an invoice may be associated to one or more transaction details, such as, product or service delivery dates, shipment invoices and signatures, product or service status, tracking information and the like.

At step 218, the recipient and/or the payer may choose to trigger a dispute to the invoice. If there is a dispute, the method proceeds to step 220. At step 220, the payer informs the controller of the dispute. At step 222, the controller informs parties, such as, the recipient, and processes the dispute. At step 224, the controller takes the appropriate action to assist in resolving the dispute, which may include providing tracked information to the payer and/or recipient, promoting negotiation and the like.

At step 226, the method 200 determines whether a payment is required for the transaction. If a payment is required, the method 200 proceeds to step 228. At step 228, the payer authorizes a payment and the method 200 proceeds to the method 400 of FIG. 4. If a payment is not required, the method proceeds from step 226 to step 230. At step 230, the controller informs parties, such as, the recipient and/or the payer, of the transaction final status and the method 200 proceeds to step 232. The method 200 ends at step 232.

FIG. 3 depicts an account payable flow diagram of one embodiment of a method 300 of operation of the financial system in FIG. 1. The method 300 starts at step 302 and proceeds to step 304. If the payer does not have an account, the method 300 proceeds from step 304 to step 306. At step 306, the payer registers for an account. The account may generate customer information on the controller. If the payer has an account, the method 300 proceeds to step 308. At step 308, the payer logs-on to the account.

At step 310, the method 300 checks if the payer is dealing with a controller generated invoice. If the controller did not generate an invoice, the method proceeds from step 310 to step 312. At step 312, the payer generates a controller invoice. The controller may generate a standard invoice. The invoice triggers a financial transaction. The financial transaction may be defined by a reference number that is associated to every step and record related to an invoice and may include transaction processing, transaction requests, transaction messages, transaction disputes and other transaction details. The transaction details include information such as, for example, the kind of products or services that initiated the invoice, parties' agreement details and the like. The unique reference number allows the involved parties to generate an electronic tracking mechanism. The electronic tracking mechanism is intended to replace the need for paper tracking.

At step 314, the recipient and/or the payer may choose to trigger a dispute to the invoice. If there is a dispute, the method 300 proceeds to step 316. At step 316, the payer informs the controller of the dispute. At step 318, the controller informs other parties, such as, the recipient, of the dispute. At step 320, the controller assists in resolving the dispute, which may include providing tracked information to the payer and/or recipient, promoting negotiation and the like. At step 322, the method 300 determines whether a payment is required for the transaction.

If a payment is required, the method 300 proceeds to step 324. If there is no dispute, the method 300 proceeds from step 314 to step 324. At step 324, the payer authorizes the payment and a request for payment by for instance a payer bank will be generated. At step 326, the controller processes the request for payment and the method 300 proceeds to the method 400 of FIG. 4. If a payment is not required, the method 300 proceeds from step 322 to step 328. At step 328, the controller informs the parties of the transaction status and the method proceeds to step 330. At step 330, the method 300 ends.

FIG. 4 depicts a flow diagram of one embodiment of a method 400 of operation between the controller and the partner bank of FIG. 1. If a payment is required, the method 200 of FIG. 2 and the method 300 of FIG. 3 proceed from steps 228 and 326, respectively, to step 402 of method 400. At step 402, the controller informs involved parties of the processed invoice. At step 404, the controller generates a transaction record that includes the reference tag or unique reference number associated with the invoice and other information. The processed transaction may generate/edit data in the customer data 124, transaction data 126, and/or financial institution data 128 of the controller (described in FIG. 1). The controller may access rules and regulations from external sources. The controller may apply such rules and regulation to the processed transaction.

At step 406, the controller forwards a request to a partner bank. The request may include a reference tag that identifies the processed transaction. The request may also include parties' information, such as, names, financial institution name/identification, account information and the like. At step 408, the partner bank processes the controller request, which includes debiting of accounts, crediting of accounts and the like. The partner bank may communicate with the recipient financial institution and/or payer financial institution to process the controller request.

As one aspect of the present invention, controller, partner bank, payer bank and recipient or vendor bank are identified as separate institutions. In accordance with a further aspect of the present invention, a controller may be located or operated by a bank or an institution or a company. A bank or an institution or a company may be a partner bank. However it may also be a recipient bank or a payer bank. In accordance with another aspect of the present invention, a payer bank may be an account at a bank, an institution or a company. Also, a recipient bank may be an account at a bank, an institution or a company. Also, a partner bank may be an account at a bank, an institution or a company. Accordingly, it may be possible, that all accounts and the controller are within one bank or institution or company. The accounts may also with different banks. Other possible configurations of accounts, controller and banks, institutions or companies are fully contemplated as aspects of the present invention.

At step 412, the method 400 checks if the partner bank process encountered any problems. If there is a problem, the method 400 proceeds to step 414. At step 414, the controller receives and informs the parties, such as, payer and the recipient, of the problem. At step 416, the controller facilitates resolving the problem, which may include providing tracked information to the payer and/or recipient, promoting negotiation, reinitiating the payment process and the like. At step 418, the method 400 checks if the request needs to be reprocessed. If the request needs to be reprocessed, the method 400 proceeds from step 418 to step 406. If the request does not need to be reprocessed, the method 400 proceeds from step 418 to step 420. At step 420, the method 400 checks if a payment needs to be processed. If a payment does not need to be processed, the method 400 proceeds from step 420 to step 422. If there is no transaction problem, the method 400 proceeds from step 412 to step 422. At step 422, the controller informs involved parties of the final transaction status and the method 400 proceeds to step 424. At step 424, the method 400 ends.

The above has provided diagram and transaction flows of methods and systems which are aspects of the present invention. The following will describe a further embodiment in accordance with further aspects of the present invention.

It will have been recognized by one of ordinary skill in the art that the above reflects methods and systems performing straight-through processing of invoices. The straight-through processing may take place from a recipient recipient's a vendor's as well as from a banker's perspective. Further methods and systems are provided that may further enhance the functionality of a invoicing and/or a payment system.

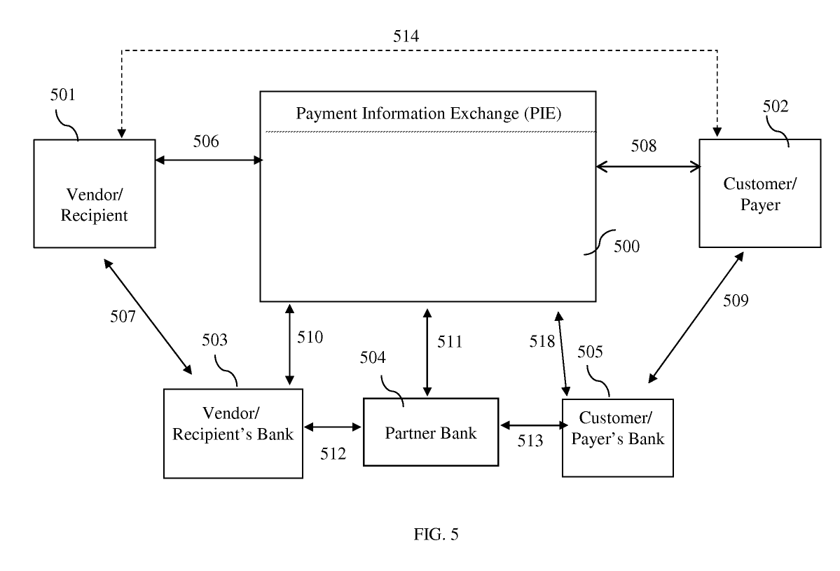

To facilitate the description of different aspects of the further embodiment FIG. 5 provides a diagram of a payment system 500 in context with different parties but with details that may be in addition to details or in a further embodiment may be different as provided in the diagram of FIG. 1. In FIG. 5, 500 is the Payment Information System (PIE) which is an invoice payment system which can provide the functionality and the steps of the controller 104 in FIG. 1. Parties that system 500 can communicate with are: a recipient 501, a payer 502, a partner bank 504, a recipient's bank 503, and a payer's bank 505.

There are different communication channels between different parties. Preferably all communications are communications over a network using for instance electronic messaging. These channels may include channel 506 between recipient and system 500; channel 508 between system 500 and payer 502; channel 511 between system 500 and partner bank 504; channel 513 between partner bank 504 and payer's bank 505; channel 512 between partner bank 504 and recipient's bank 503; channel 510 between recipient's bank 503 and system 500, and channel 518 between system 500 and payer bank 505.

Other channels may exist through which transactions with system 500 are initiated but which are not directly connected to the system 500. This may include a channel 514 between recipient 501 and payer 502. Such a channel may, for instance, include a printed invoice that is sent by 501 to 508 by mail. Other channels may include channels 507 and 509, which are private connections between parties and their banks.

A channel 510 is provided between the system 500 and the recipient's bank 503. This channel, in accordance with an aspect of the present invention, is used to download by 500 from 503 or to upload by 503 to 500 information related to the bank account of recipient 501. This may assist system 500 to create for recipient 501 a consolidated view of paid and still outstanding payments, including payments that were not done through system 500. This consolidated information about invoice payment status is then provided by system 500 to recipient 501.

A similar solution related to invoice and/or payment reconciliation may be provided by system 500 with payer bank 505 for payer 502 by using channel 518.

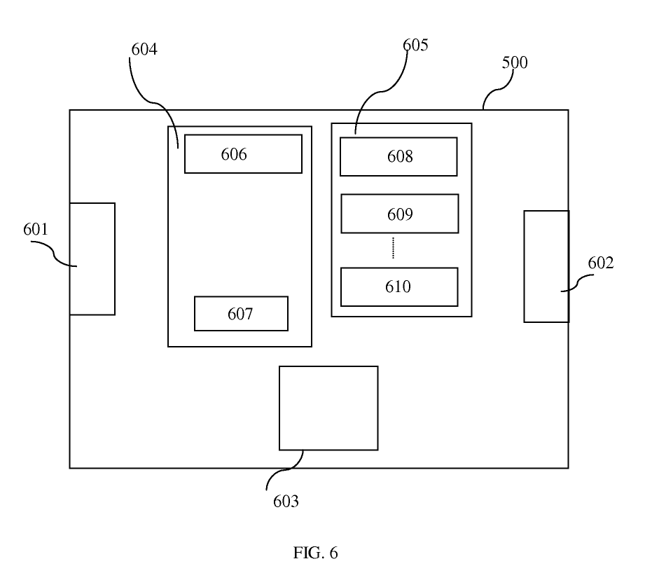

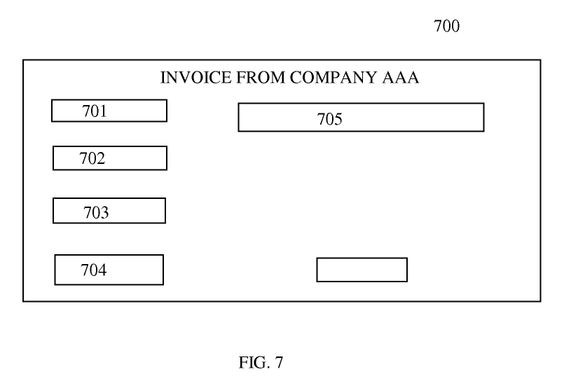

FIG. 6 provides a diagram of system 500 with a view of functional units. It is to be understood that this diagram is provided to identify some functional units. One of ordinary skill in the art will be aware that such a diagram is not complete and that a system may include units, for example: internal system management, security management, communication management, interface management and other functions which may be common to enterprise strength systems.

The system of diagram of FIG. 6 comprises a database 603, which may contain all data and instructions to execute the steps for performing the tasks of the system. Such a database may comprise several databases which may be located on different computers. Other functional elements, for instance to perform certain tasks or to contain certain information, may also be contained in the database.

The system further has a profile unit 604. The profile unit may be part of a database. The profile unit 604 contains information related to parties which can be reached through the earlier identified channels. A profile 606 of a party may for instance contain information about a party, such as an e-mail address and for instance about a preferred format of a message to communicate with another party of which a profile is contained in 607. The unit 604 may contain profiles of a plurality of parties. Instructions or functional units that require said profile information may be provided with access to the profile. Vendor, payer, vendor bank, payer bank and partner bank as well as other parties all may have their own profile.

The system 500 further may have an engine unit 605. The engine unit 605 may contain one or more engines which for illustrative purposes are indicated as 608, 609 and 610. However, the number of engines is not restricted and can be any number of engines required to perform tasks as needed. An engine contains instructions to execute specific methods or steps. These instructions may have access to data in the database and to profiles and may be able to communicate over the earlier provided or other channels. Engines may also have access to data external to the system. Another term for an engine may be a computer program or application, a procedure, a function, a routine, or other related terms. An engine may be a stand-alone computer program; it may also be part of a collection of computer programs. The engine unit may be part of a database. An engine may also have its own database. An engine may be located on its own server or computer, despite being part of a system.

Furthermore, the system may have facilities to translate transaction data coming in from a party into an internal system format; and to translate an internal system format into a format that is preferred by a party. Such an external format may be, for instance, a SWIFT, Fedwire, NACHA, or EDI format or may be any other format. It may also be a format that is applied by an ERP system. It may also be a format that is provided by standard bodies such as RosettaNet or other standard bodies. Facility 601 may be inputted with invoice data from a recipient in a data format in accordance with its preferences. The facility 601 is able to translate the format to any desired format for other parties or to an internal format. For instance, a message in external format of the recipient may be first translated to an internal format. Assume that this is a message for a payer who may have its own preferred format in a profile. A facility 602 may then translate data from the internal format to the preferred format according to the profile of the payer. Translation may work in the reverse direction also. Details about preferred formats may be stored in a party profile or elsewhere in a database.

To provide context for the engines the following provides a summary of the process flows for Accounts Receivable and Accounts Payable transactions as related to FIG. 5.

### Description of Transaction Flows—Accounts Receivable

The recipient 501 accounts receivable department logs onto system 500 having a secure portal and transmits invoices through the system to the payer 502.

System 500 notifies the payer 502 via secure email that an invoice is available. The payer 502 clicks on the “View Invoice” link. If the invoice is correct, the payer 502 proceeds with their approval process. Once the invoice is approved, the payer 502 clicks on the “Pay Here” link in system 500. This brings the payer 502 to the payment screen where they schedule the payment. System 500 initiates the payment through the partner bank 504 with a tag linking the payment to the remittance information.

If the invoice is not correct, the payer 502 clicks on the “Dispute Management” link. This brings the payer 502 to the dispute management screen. The payer 502 then communicates through system 500 to the recipient 501 the nature of the dispute. This communication continues until the dispute is resolved. The recipient 501 adjusts the receivable to reflect the corrected amount. These messages and adjustments are captured creating a permanent audit trail.

Now that the dispute is resolved and the invoice approved, the payer 502 clicks on the “Pay Here” link in system 500. This brings the payer 502 to payment screen where they schedule the payment. System 500 initiates the payment through the partner bank 504 with a tag linking the payment to the remittance information.

System 500 will send a funds transfer message (FTM) to the recipient 501 accounts receivable department. The FTM instructs the recipient 501 to retrieve information about an incoming payment. The FTM delivers the tagged remittance information to the accounts receivable department in an accurate and secure manner. The remittance information will automatically flow to the general ledger relieving the accounts receivable.

System 500 downloads bank transactions from the recipient's bank 503 and uploads the information into system 500. This allows bank reconciliation to be performed in system 500.

### Description of Transaction Flows—Accounts Payable

A payer 502 either receives a paper invoice or an electronic invoice. If it is a paper invoice, then the payer 502 logs into system 500 and sets up the payable. If it is an electronic invoice, the payable is already in system 500. All invoices can now be downloaded into the general ledger.

If the invoice is accurate, the payer 502 proceeds with the approval process, which can be set up in system 500. Once the invoice is approved, the payer 502 clicks on the “Pay Here” link in system 500. This brings the payer 502 to the payment screen where they schedule the payment. System 500 initiates the payment through the partner bank 504 with a tag linking the payment to the remittance information.

If the invoice is not correct, the payer 502 clicks on the “Dispute Management” link. This brings the payer 502 to the dispute management screen. The payer 502 then communicates through system 500 to the recipient 501 the nature of the dispute. This communication continues until the dispute is resolved. These messages are captured creating a permanent audit trail.

Now that the dispute is resolved and the invoice approved, the payer 502 clicks on the “Pay Here” link in system 500. This brings the payer 502 to the payment screen where they schedule the payment. System 500 initiates the payment through the partner bank 504 with a tag linking the payment to the remittance information.

System 500 will send a funds transfer message (FTM) to the recipient 501 accounts receivable department. The FTM instructs the recipient 501 to retrieve information about an incoming payment. The FTM delivers the tagged remittance information to the accounts receivable department in an accurate and secure manner.

System 500 downloads bank transactions from the payer bank and uploads the information into system 500. This allows bank reconciliations to be performed in system 500 for the payer. Similar reconciliations can be performed for the recipient.

### The Engines

Earlier herein, an engine unite 605 as part of the system 500 in FIG. 5 was provided. The engine unit can have one or more engines for performing specific tasks. The following engines are provided as an aspect of the present invention.

A first engine is a maintenance engine. The maintenance engine provides facilities to update, change or correct information related to a party participating in the processing of an invoice. A maintenance engine may for instance be used by an external party through for an Internet connection to update a profile. Such an update may be done manually by signing on to a screen or by sending a message that will update the profile.

Another engine is a visibility engine. The visibility engine creates a screen or a message that provides a party such as the recipient or a payer with the status of an invoice. When an invoice is paid but is still in process at a bank, the visibility engine will collect status information from the partner bank on the status of payment and provide that information on the screen or in the message. The visibility engine may also provide information on when the money paid by the payer will appear in the account of the recipient.

Another engine is a payment scheduling engine. The payment scheduling engine has access to available discounts for a particular payer and terms for a discount. The recipient may provide a list of discounts, wherein the discount granted to a payer depends on the time of payment after an invoice was issued. For instance, no discount may be granted 31 days or later after an invoice was issued. A discount of 6% may be granted when an invoice is paid within 7 days. A discount may be 3.5% when an invoice is paid later than 7 days but earlier than 22 days. A discount may be 1% when paid after 21 days but earlier than 31 days. The payment scheduling engine may provide payment advice to a payer, calculating and determining an optimal payment schedule for a payer with a plurality of invoices to pay.

Another engine is a pooling engine. In one example, a company may have multiple plants or divisions buying the same materials from the same vendor. Often the buying company may forego a significant volume discount because the different divisions or plants buy under different contracts. In a pooling contract, all divisions may buy under one contract and for instance under one Purchase Order, split up over different invoices. The vendor issues the invoices in one batch to the system 500, which according to a company profile has rules of an invoice to be split up to the ordering divisions or plants. Each individual plant may be invoiced by the system and payment will be collected. When payment is received on time the discounts, including volume discounts will be administered by the pooling engine. In such a case, the payer may provide the system to determine the discounts based on all or some parties meeting discount requirements. A failure by one or more divisions or plants to pay may diminish the overall discount but may not completely remove it. The pooling engine is beneficial to the payer as it provides an opportunity to obtain volume discount it would otherwise not be entitled to. The pooling engine is beneficial to the vendor as it may prevent the vendor from having to pursue a greater number of individual payers.

Another engine is the dispute resolution engine. The dispute resolution engine enables resolution of a dispute over an invoice. For instance, when a payer disagrees with an invoice it may be over details in the invoice. Usually, it may take some time for a recipient to receive and process a complaint or disagreement over an invoice. Many times disagreements may be over minor details that can easily be resolved, removing the invoice further dispute. The dispute resolution engine provides the payer the opportunity to alert the recipient that there is a disagreement over an invoice. The recipient may resolve the issue, perhaps after payer and recipient exchange several messages. After resolution, an amended or changed or accepted invoice may be considered to be correct and may be paid by the payer.

Another engine is an advance notice engine. The advance notice engine may provide an alert to the recipient when a payer has agreed to pay an invoice. While it may take some time before the money is actually transferred from the payer's bank to the recipient bank, the recipient may be notified that payment is on its way and may be notified of expected day of receiving the money. Recipient may also be alerted that money will not be received when an unexpected event prevents money from being transferred.

The advance notice engine may help in advance credit planning and cash flow management. For instance, an early notification of payment by the payer to the vendor of an invoice may help the vendor to forecast its cash position within a certain time period. For instance assume the payer 502 in FIG. 5 transfers an order of payment of an invoice to controller system 500. At that stage, actual transfer of money from payer bank 505 to vendor bank 503 is part of a process that has limited influence from payer 502. At that stage, the vendor 501 can be reasonably sure that within a certain time frame the money will actually be in his bank account 503. In known payment systems, a vendor will generally know that a payment is made when the money is actually in his bank or bank account. A substantial time may have passed from intent to pay by the payer to the payment actually being in the bank account.

For purposes of cash management, it may be beneficial to a vendor to be able to make a reasonable assumption of cash available at a certain point in the future. It may help in assessing needs for credit or avoid potentially expensive credit lines. The earliest notification the vendor may get is when as stated above the payer has transferred an order for payment to the controller system. The forecasting of when moneys related to an invoice will be in a vendor's bank account will likely become more accurate as the payment process advances through the different parties. A forecast of a date when money may be expected to be in a bank account of a vendor may be provided by a forecasting engine which is another engine that may be part of the controller system.

The controller system may be used in thousands if not millions of invoice transactions. Accordingly, the database that is a part of the controller system may contain the payment history of all transactions and a forecasting engine may be able to search payment history related to different parties, amounts, types of invoices, types of transactions, banks, currencies and other data that is relevant to an invoice or a payment of an invoice. The historic data may be correlated to a present payment and allow a forecasting engine to make a forecast of a time of payment of the invoice after an order of payment was provided by the payer. The forecasting engine may also provide an assessment or forecast about the likelihood that a payment will be rejected for instance for lack of funds in a payer's account. The forecasting engine may provide forecasts with a greater confidence level as the payment process advances. Accordingly, the controller system may provide additional notifications of payment to the vendor when the payment process advances.

A notification of payment of an invoice to a vendor may thus contain a message related to the status of payment. For instance, in a first embodiment in accordance with an aspect of the present invention a notification message to a vendor may contain the message that the payer has sent an order for payment of the invoice and that such order was received by the controller system. In a further embodiment, the controller system may provide an expected date of actual money in the bank. Such a message may also include a measure of confidence on the correctness of the forecast. In another embodiment the controller system may provide a forecast on any of the stages of payment, which may include a measure of confidence.

The controller system may thus provide, in accordance with a further aspect of the present invention, another notification of payment when the controller system transfers an order for payment to a partner bank.

In accordance with another aspect of the present invention, the controller system may provide a notification of payment of an invoice to a vendor in one or more of the following situations:

when the partner bank 504 transfers an order of payment to a payer's bank 505 and informs the controller system 500 of this transfer;

when the partner bank 504 receives an order of payment from a payer's bank 505 and informs the controller system 500 of this order;

when the partner bank 504 transfers an order of payment from a payer's bank 505 to a vendor bank 503 and informs the controller system 500 of this order;

(All the above confirmations are thus early confirmations)

when the partner bank 504 receives a confirmation of receipt of payment from a vendor bank 503 and informs the controller system 500 of this confirmation.

In accordance with a further aspect of the present invention, an early notification of payment is provided, which may be received at any time before the payment for the invoice is received in the bank account of the payer, can be used for cash, currency and credit management and optimization. Early payment information over a plurality of invoices may be aggregated to forecast an overall cash status. Such information may be used to anticipate actions to strengthen a cash position. It may also be used to prevent engaging in debts. It may also be used by a vendor for postponing payments which combined with a forecasted lack of invoice payments may potentially lead to unwanted cash or debt situations. The early notification may be used for all purposes which will help assess or optimize a cash and/or a debt and/or a credit status for the vendor. Herein, the term cash management will be used for such optimization and assessment activities.

Another engine that is provided as an aspect of the present invention, is a business process management (BPM) engine. Such an engine is a configurable engine which directs and orchestrates the flow and order of transactions and initiates, retrieves, stores and processes messages and records related to a transaction. A BPM engine thus may be configured to implement and execute the instructions related to the methods disclosed herein as aspects of the present invention. A BPM engine may be configured to recognize a specific party or type of party such as vendor, payer, partner bank, payer's bank or vendor bank and execute or configure the instructions to be executed by the controller system accordingly. For instance, a BPM engine may recognize an invoice of a vendor as one requiring early payment notifications and payment forecasts. The BPM engine accordingly applies the advance notice engine.

The BPM engine may also recognize a payment as an international payment and may include a currency engine to determine correct and appropriate currency rates.

Business Process Management (BPM) and its different aspects, including its use of standards such as related to Services Oriented Architecture (SOA) are well known to one of ordinary skills in the art. Accordingly, the BPM engine as an aspect of the present invention may be assumed to contain all elements of a BPM application and interfaces, applications and messages related to SOA or other standards.

Another engine is an authentication and security engine. This engine authenticates the users and systems that participate in any of the transactions. Such an engine may check the credentials, such as usernames and passwords. It may also use other authentication data such as hidden codes, IP addresses or biometrics from human users to allow access to the system. An authentication system may check access history of a user or other data available to the system and may request additional information from a user. It may provide access to the system or it may deny access. Furthermore, the engine may authorize certain levels of access to a user. For instance a user may only be allowed to review a transaction but not initiate one. Furthermore, the engine may provide security measures including but not limited to encryption services, assigning and re-assigning passwords, surveillance of use of the systems and providing alerts if breach of security is suspected.

For instance, for maintenance and system management purposes the engines provided and described herein as an aspect of the present invention may be implemented or recognized as an individual program or engine. However, an engine may use or re-use aspects of another engine or another program and may be embedded in two or more engines. An engine may also be a description of a functionality of a computer program that has a broad range of functionalities and an engine may not be separable from other program instructions. The term engine in such a case may be used to describe a functionality or a group of functionalities without being separable from its environment as an individual unit.

One or more of the transaction engines that are an aspect of the system or methods as provided herein may be provided by for instance the Cash Will application of Nucleus Software.

### The Unique Transaction Tag

As a further aspect of the present invention, each invoice which is processed by the system is provided with a unique tag, which may be an 18 digit decimal number. The unique tag may also represent a series of digits and others symbols. A unique tag is unique at least as it relates to any other unique tag used in the system. The assigned unique tag to an invoice will be attached to the invoice and any identified transaction or record related to the invoice. This includes messages leaving the system to outside parties as well as messages about an invoice entering the system. Accordingly, a traceable record on any of the transactions is available in such a way that it is at least traceable to an invoice it is related to. Furthermore, the system does not have to rely on information or identifiers provided by outside parties to track and trace the progress of transactions. The unique identifier also allows quick retrieval of information related to an invoice. It also allows transformation of data formats without losing information about an invoice as different records can easily be traced and reconciled if so required.

The limitation of current systems in which payers are hesitant to provide certain information may be addressed by using a partner bank that is neutral to other parties involved in the processing of an invoice. The partner bank deals with the payer's bank and the recipient's bank. Confidential payer information required to enable a payment transaction will not be disclosed to the recipient.

The limitation of some current systems of only being available during business hours is addressed as an aspect of the current invention by making the system 500 of FIG. 5 available on-line for instance through the Internet 24 hours per day, 7 days a week, 52 weeks a year.

The limitation of some current systems of having no capabilities for easily resolving exceptions or disputes in transactions is addressed as an aspect of the current invention by providing a dispute resolution engine and an exception engine.

The limitation of some current systems of having no capabilities for providing real-time insight into the status of transactions being processed is addressed as an aspect of the present invention by the visibility engine.

The limitation of some current systems of having no capabilities for providing advance notice of payments being made is addressed as an aspect of the present invention by the advance notice engine.

The limitation of some current systems of having no capabilities for payment or discount scheduling is addressed as an aspect of the present invention by the payment scheduling and the discount scheduling engine.

The system and methods provided as aspects of the present invention include exchanging messages between banks and systems, including systems of recipient, payer and system 500 of FIG. 5. Sending and exchanging messages are for the purpose of aspects of the present invention assumed to mean the same. For instance, a system may send a message to another system. One system may also make available a message for collection by another system. This may be done, for instance, to prevent overloading of the receiving system or prevent overloading of communication channels. It is sometimes left to the receiving system to decide when to collect messages. For aspects of the present invention actively sending a message and making a message available for collection will both be covered by the term ‘sending a message’.

Management and processing of some or all of the methods provided herein as an aspect of the present invention are provided by a system. The system may be called a controller or a controller system; it may also be called an invoice payment system or an invoice processing system; it may also be called a payment information exchange or PIE. All these designations are assumed to refer to the same system. In one embodiment, the system may be located at an independent institution and may be operated as a privately owned system with no ownership by any of the other parties. In a further embodiment, the system may be owned and/or operated by one or more of the parties that communicates with the system. In another embodiment the system may be owned and/or operated as a system commonly owned by two or more parties.

The party generating the invoice herein is generally designated as being a vendor as for instance in FIG. 5 wherein the invoice generating party is a vendor 501. Invoice collection may also be performed by a third party to which invoice payment collection is outsourced. In some cases, collection of invoices may be sold to a third party, who then becomes the legal owner of the invoices and who is then responsible for collecting payments. The term vendor herein is thus intended to mean the party engaged with collection of payment of invoices and who engages with a controller system for collection of payment. The vendor bank or recipient's bank thus is a bank or a bank account which establishes legal payment of an invoice

Herein the terms payer and vendor or recipient are used. It is to be understood that a payer herein can be a person. A payer can also be a computer system. The computer system can generate, receive and process messages. It can do so automatically by executing a computer program. It can do so also by being controlled by a person. A payer may also be a party, a person or system acting on behalf of a payer or in place of a payer. The same applies to a vendor or a recipient, which can be a party, a person or a computer system or a party, person or system acting on behalf of the vendor or in place of a vendor.

The term system used herein means a computer system which includes at least a memory which can accept, store and provide data, instructions which may be stored in a memory and which form a computer program that can execute or perform methods such as disclosed herein, a processor which can execute instructions which may be provided from a memory and process data which may also be provided from a memory, input and output ports to connect to a network, and a user interface which allows a user to enter or retrieve data including instructions. A system may comprise one or more sub-systems which meets the criteria of a system.

### The Dashboard

The system and methods provided herein as aspects of the present invention create an opportunity to aggregate and display data related to invoices. The system may have access to all transactions and records related to an invoice. This may include, but is not limited to, time and source of originations, time and target of a payment, disputes, delays in payment, actual payments, accuracy of records, non-payment of invoices, on-time payments, exceptions to invoice payments, etc. This provides the system with the opportunity to organize available data in a meaningful way for analysis. For instance, one may analyze the number of disputes and accurate payments of a certain payer. One may display and analyze payment performance of a bank. One may identify accuracy of invoices per vendor. One may also use historical data and make an analysis of outstanding payments, potential cash flow problems and any other analysis that is helpful in the analysis and management of financial performance of a corporation, institution, bank or organization.

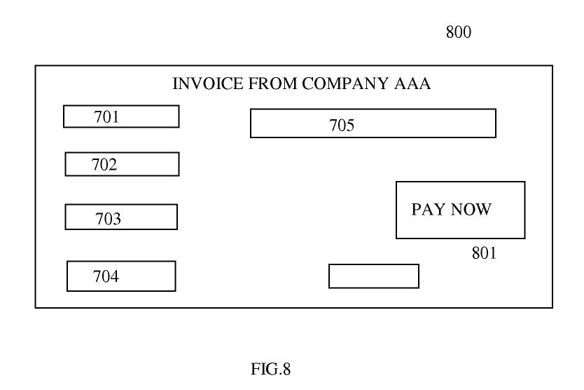

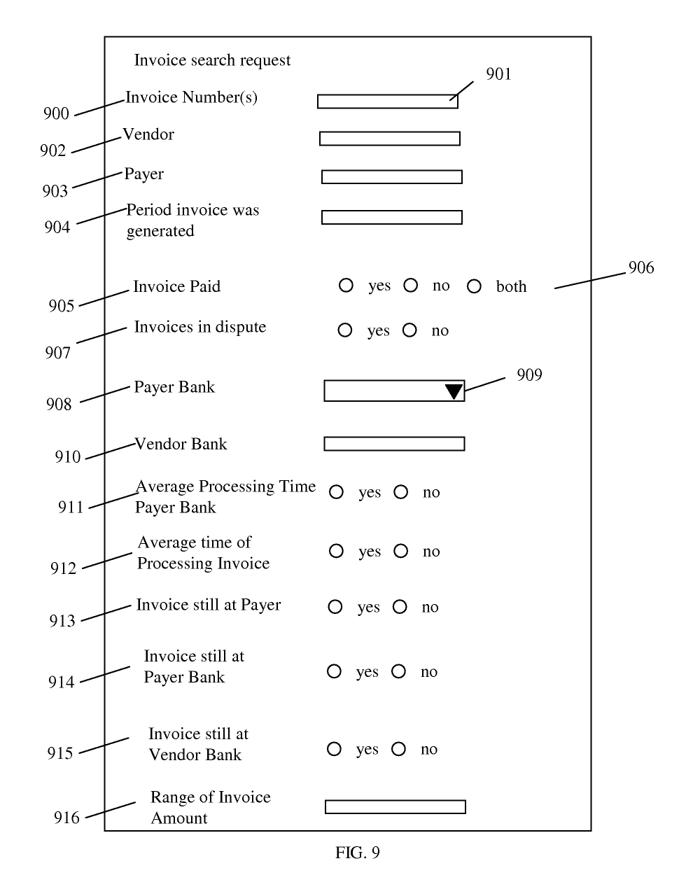

Invoice data can be retrieved using a search form or screen which may be presented on a computer display. A request may also be provided through a message such as an electronic message. FIG. 9 shows an electronic example of a search request. It is to be understood that this is merely an illustrative example. A request may be organized differently. It may have more search items. It may have less search items. It may have different search items. In fact invoices and their related transactions may be searched, and/or retrieved, and/or aggregated based on any identifiable characteristic of an invoice and/or its related transactions. The result of a search may be displayed in individual form or aggregated form, in graphical form or in character form, on a computer screen, in print, on a storage medium or in any form that is useful.

The illustrative request, as shown in FIG. 9, has a request field that shows which kind of request data has to be provided and a related data-entry field. For instance, request field 900 requests one or more Invoice Numbers that can be provided in data-entry field 901. A data-entry field can have one of different formats as is known in the art. It may be a general data-entry field that accepts any character; it may accept only data and characters in a certain format. The field may accept a single identifier, multiple identifiers, or a range of identifiers such as numbers, characters, dates, numbers and the like. The data-entry field may provide a drop down menu from which a value, one or more values or a range of values may be selected such as for instance data-entry field 909. The data-entry field may also be of a yes/no nature such as 906 which also provides the option of yes and no. Other field formats may also be used. The examples of formats provided herein are not to be construed as limiting. The formats of the data-entry fields besides 901, 906 and 909 will not further be identified in the drawing, but assumed to be appropriate to the related request field.

The illustrative fields provided in FIG. 9 further include a field 902 requesting a name or a code of a vendor. Field 903 for the name or code of a vendor. Field 904 for the period during which the invoice was generated. The search may operate under the assumption of the logical AND operation. This means that a search finds information on invoices that meet all requirements. The search may also operate under other requirements such as an OR requirement. Other requirements may also be applied.

Request field 903 relates to a name or a code for one or more payers. Request field 904 relates to a time or a period during which the invoice was for instance generated and/or provided to a payer. Field 905 is related to an invoice if it was paid or not at the date of the search request. Field 907 is related to an invoice if it is in dispute or not. Field 908 is related to a name or a code of a payer bank. Field 910 is related to a name or a code of a vendor bank. Field 911 is related to generate for all relevant and matching invoices a calculated average processing time by a payer bank. Field 912 is related to the average time of processing an invoice overall. Field 913 searches for invoices still being processed by a payer. Field 914 searches for invoices still being processed at a payer bank. Field 915 is related to invoices being at a vendor bank. Field 916 is related to setting a value or a range of values of invoices being searched.

It should be clear that the provided search fields are illustrative in nature and that other search fields are possible and these are fully contemplated.

FIG. 9 shows a search on invoices. One may provide other searches. For instance, one may search on transactions related to a bank or a payer. It was shown above that the controller system may be informed on any transaction that takes place related to an invoice, at a minimum when a transaction goes or comes from a vendor, payer and partner bank. One may make an arrangement whereby a partner bank informs the controller system when a transaction with a payer and/or vendor bank takes place. This allows a fairly complete tracking of transactions around an invoice and these transactions would be available for individual or aggregated retrieval and display for instance by way of a search.

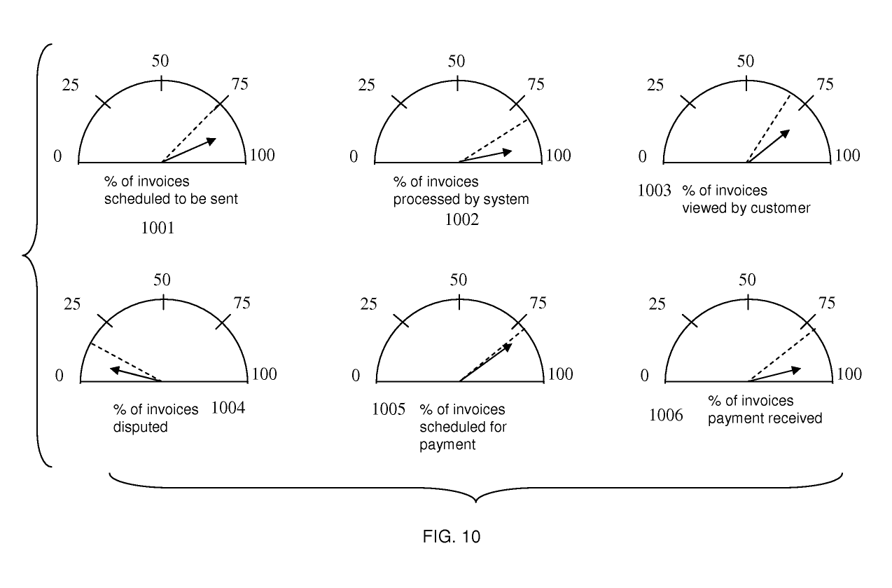

One may display aggregated results in a dashboard type of presentation. For example, FIG. 10 shows a performance dashboard of the status of invoices. A dashboard may be designed for a specific manager or function in an organization that is involved with invoices. For instance, a dashboard as shown in FIG. 10 may be intended for a collection manager who is interested in an invoice remittance cycle. FIG. 10 shows 6 percentage-type of meters. A dotted or dashed line indicates an acceptable threshold. An arrow shows an actual percentage of invoices at a stage in a remittance cycle. Meter 1001 shows an arrow indicating the percentage of invoices scheduled to be sent. This shows to be about 90%, while the dotted line indicates that 75% would be acceptable. The description of each stage is provided below each of the six meters. Meter 1002 shows a percentage of invoices processed by the system. Meter 1003 shows a percentage of invoices viewed by customers. Meter 1004 shows a percentage of invoices that is being disputed. Meter 1005 shows a percentage of invoices scheduled for payment. Meter 1006 shows a percentage of invoices for which payment is received. The aggregates of transactions that are reflected by the meters are accessible to the system and may be collected and presented for a pre-set period. For instance, the meters may reflect a situation over a period of 30 days. Or it may reflect the situation over a calendar month. Or it may reflect any other pre-set period or time frame.

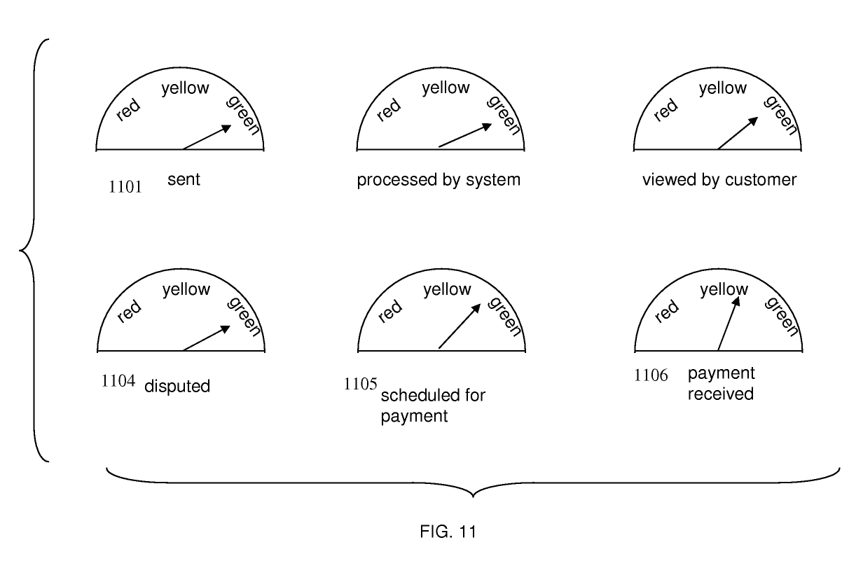

Another manager or function may be a company controller. FIG. 11 shows a dashboard that may be used by a financial controller to review an invoice remittance cycle. Because the system, which is an aspect of the present invention, allows an invoice to be linked with the payment process, the controller can be provided with an end-to-end view of the remittance cycle. The meters as shown in FIG. 11 in this example reflect the same 6 performance issues as were shown in FIG. 11. However, instead of percentages a performance color is used: red, yellow and green. A meaning provided to colors may be: red, requires urgent attention, yellow requires attention, green no immediate attention required. For instance, meter 1101 shows the number of invoices sent being in the green area, which indicates good performance. Meter 1104, indicating number of invoices in dispute is also indicating a green status. Comparing this to meter 1004 in FIG. 10 it means that a low percentage is in dispute. Meters 1105 and 1106 related to scheduled payment and actual payment are in yellow. This aspect requires attention as of course bad questionable performance in scheduled payments will lead to questionable performance in actual payments.

At the senior level summary, the executive or manager can tell at a glance if all issued invoices are being processed and paid on a timely basis. Rather than percentages colors may be used to indicate performance. Green, for instance, may indicate that 95% of the predetermined level hurdle rate for each step in the remittance cycle.

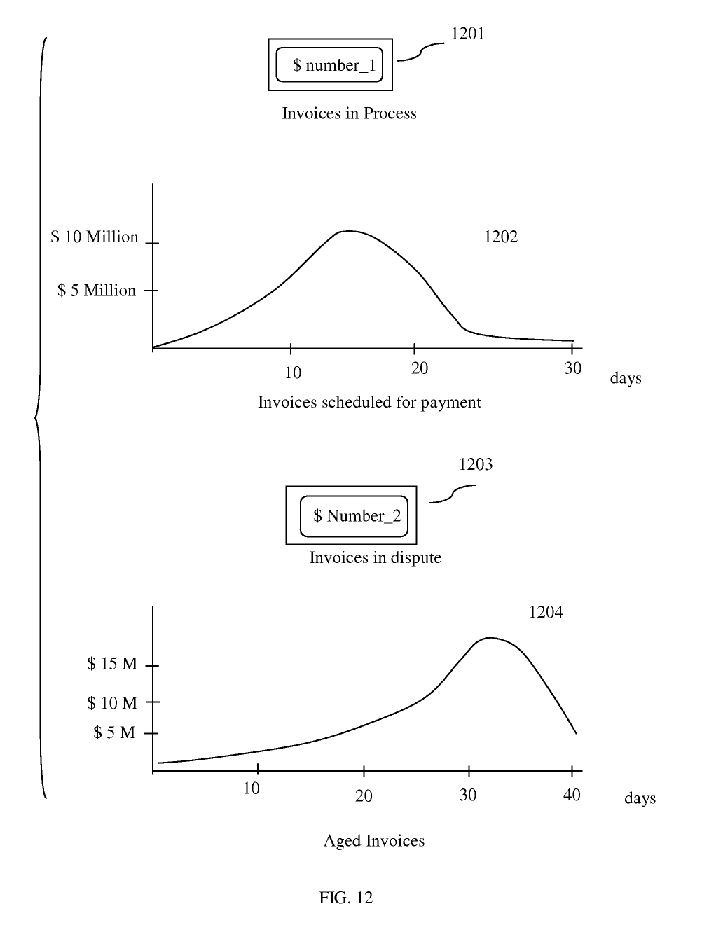

FIG. 12 shows a dashboard that a Chief Financial Officer (CFO) may want to use. It has in this illustrative example 4 indicators. Indicator 1201 provides a number, which may be a dollar number indicating the value of invoices that is in process. Indicator 1202 shows a curve of the value of invoices being scheduled for payment over the next 30 days. Indicator 1203 shows the value of invoices being in dispute. Indicator 1204 shows a curve over time of a value of aged invoices.

FIGS. 10, 11 and 12 are illustrative examples of possible dashboards. Other dashboards, using different indicators, including but not limited to pie charts, bar diagrams, scatter diagrams, radar diagrams and any other display or diagram that provides an indicator may be used. One may provide a dashboard for different functions and purposes. The availability of the invoice and all related transactions enables virtually any aggregation, analysis as well as forecast and planning activity as most end-to-end data is available within the system and accessible by the controller system.

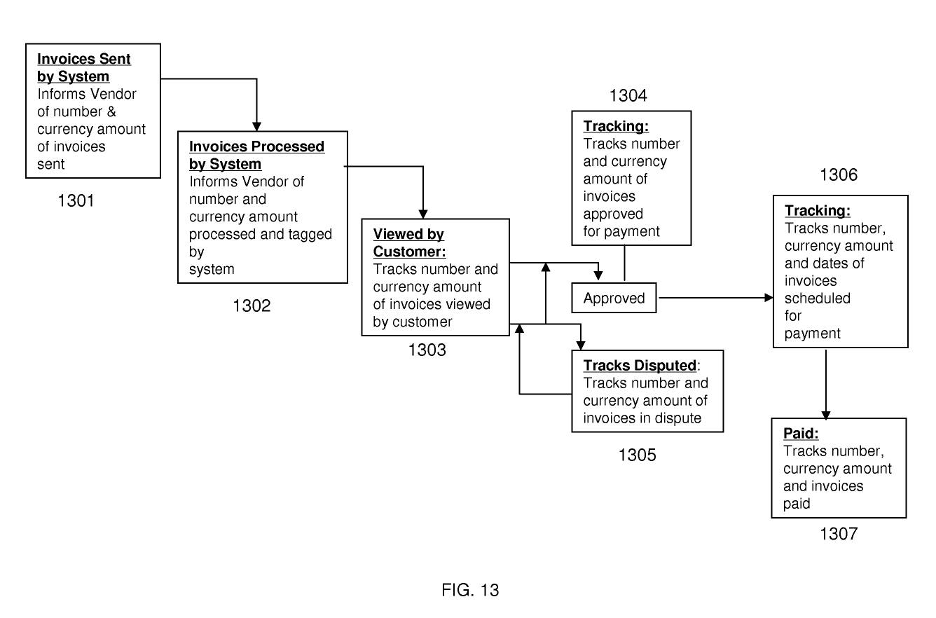

The ability for a system as provided herein as an aspect of the present invention allows for end-to-end gathering, aggregation and analysis of almost all aspects of invoice processing: from initial release from the invoice by the vendor to the system to the final payment of the invoice. This ability to process and track invoices during its lifecycle is illustrated in FIG. 13. The steps of FIG. 13 apply to individual invoices, as well as to a group of invoices. In step 1301, the system accepts invoices from a vendor and informs the vendor of the number of invoices and the currency amount or value represented by the sent invoices. While not specifically mentioned in all steps in FIG. 13, the system may track and report on other aspects also, including but not limited to: date related to an invoice transaction, payer related to an invoice, partner bank, payer bank and vendor bank related to a transaction. In step 1302, the system informs the vendor after processing invoices about the number and currency value of the processed invoices viewed by a payer. This is possible because the system may provide a payer only with a message stating that an invoice is ready for viewing. If the payer wants to view the invoice, he/she has in that case to go on-line, log-in to view the invoice. That step of viewing was provided earlier as step 216 in FIG. 2.

After viewing an invoice a payer may approve an invoice. A payer may also dispute an invoice. If an invoice is approved the system in step 1304 tracks the number of approved invoices and the currency amount representing the value of the approved invoices. In step 1305, the system tracks the aspects of disputed invoices.

Approved invoices are scheduled for payment. In step 1306, the system tracks the number and value and dates of invoices scheduled for payment. In step 1307, the system tracks number and value of paid invoices.

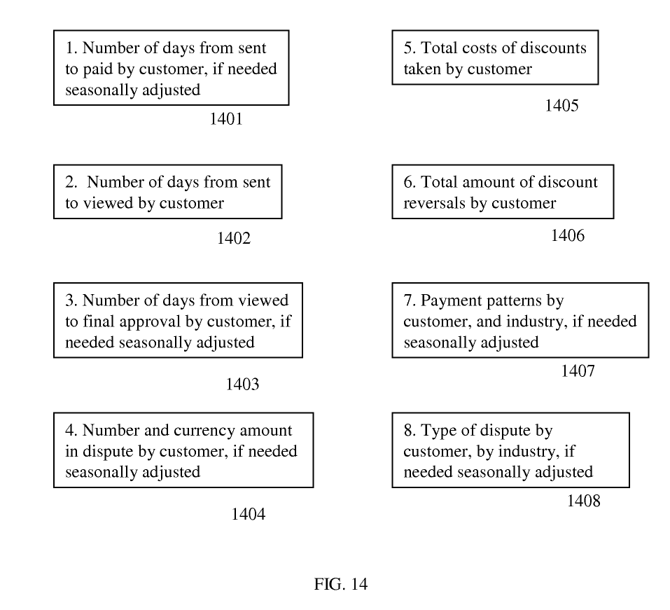

An invoice processing system as provided herein in accordance with an aspect of the present invention can provide different statistical analyses of the invoice as they are being processes. FIG. 14 provides 8 illustrative examples of possible analyses from the transaction data available in the system. It should be clear that these examples are not limiting and many other analyses are possible. The illustrative analyses provided in FIG. 14 are:

1401 Number of days from sent to paid by customer, if needed seasonally adjusted
1402 Number of days from sent to viewed by customer
1403 Number of days from viewed to final approval by customer, if needed seasonally adjusted
1404 Number of invoices and currency amount in dispute by customer, if needed seasonally adjusted
1405 Total costs of discounts taken by customer
1406 Total amount of discount reversals by customer
1407 Payment patterns by customer, and industry, if needed seasonally adjusted
1408 Type of dispute by customer, by industry, if needed seasonally adjusted

### Examples of Screenshots

As an illustration of one or more aspects of the present invention, examples of user interfaces are provided that may be applied in different stages and by different users and user roles of a financial system as provided as an aspect of the present invention. It should be clear that many variations of a user interface are possible and that a user interface could provide more, less and different information as shown in the drawings. Its purpose is to illustrate one or more aspects without being limiting.

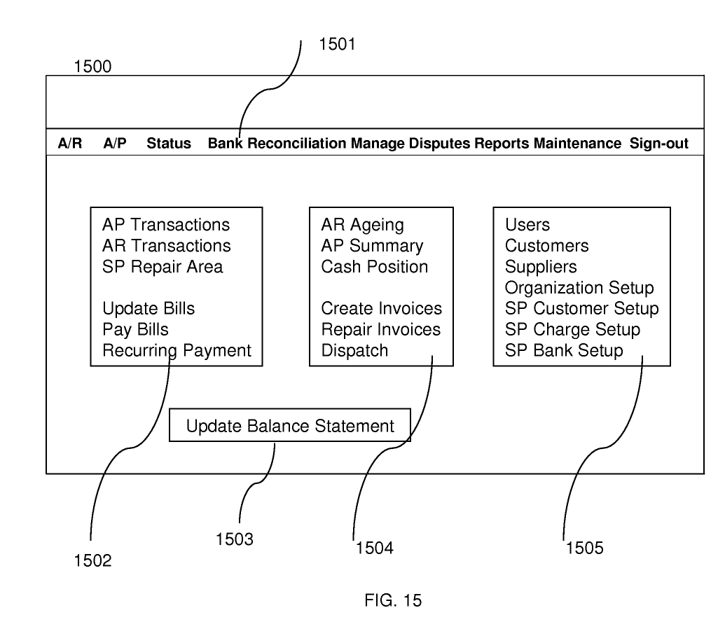

FIG. 15 shows a diagram of a possible main menu interface 1500. Main categories are provided in a bar menu 1501. Each item may be hyperlinked so that clicking on the item brings up a new interface. Other possible groups of interfaces and menu items are also shown. Each item or group shown herein may be hyperlinked to another interface. Group 1502 includes menu items related to AP Transactions, AR Transactions, SP Repair Area, Update Bills, Pay Bills and Recurring Payment. Group 1503 relates to updating a balance statement. Group 1504 relates to AR Ageing, AP Summary, Cash Position, Create Invoices, Repair Invoices and Dispatch. Group 1505 relates to maintenance such as setting up Users, Customers, Suppliers, Organization Setup, SP Customer Setup, SP Charge Setup, SP Bank Setup.

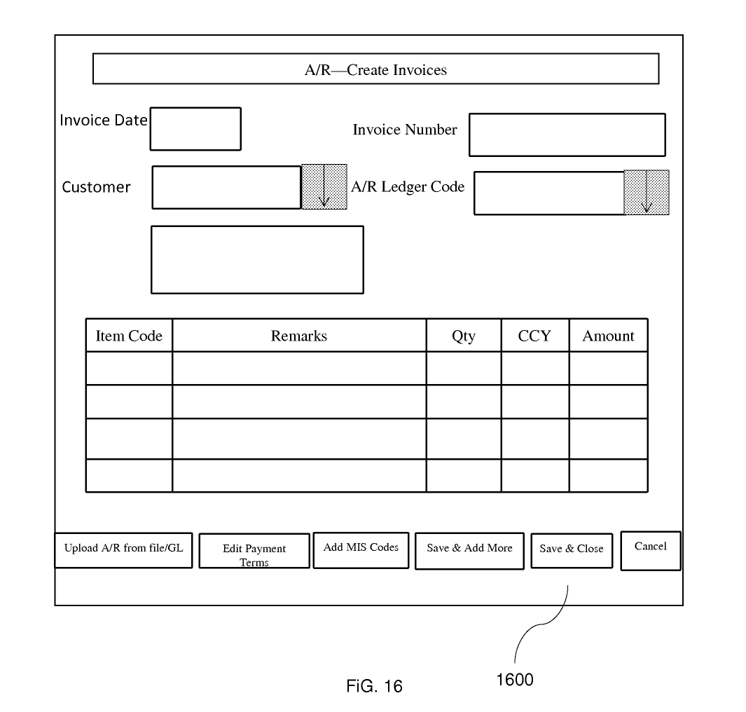

FIG. 16 shows an interface 1600 that provides options to create invoices by uploading a file from GL or by manually entering data. Data fields to comply to standard invoice parameters.

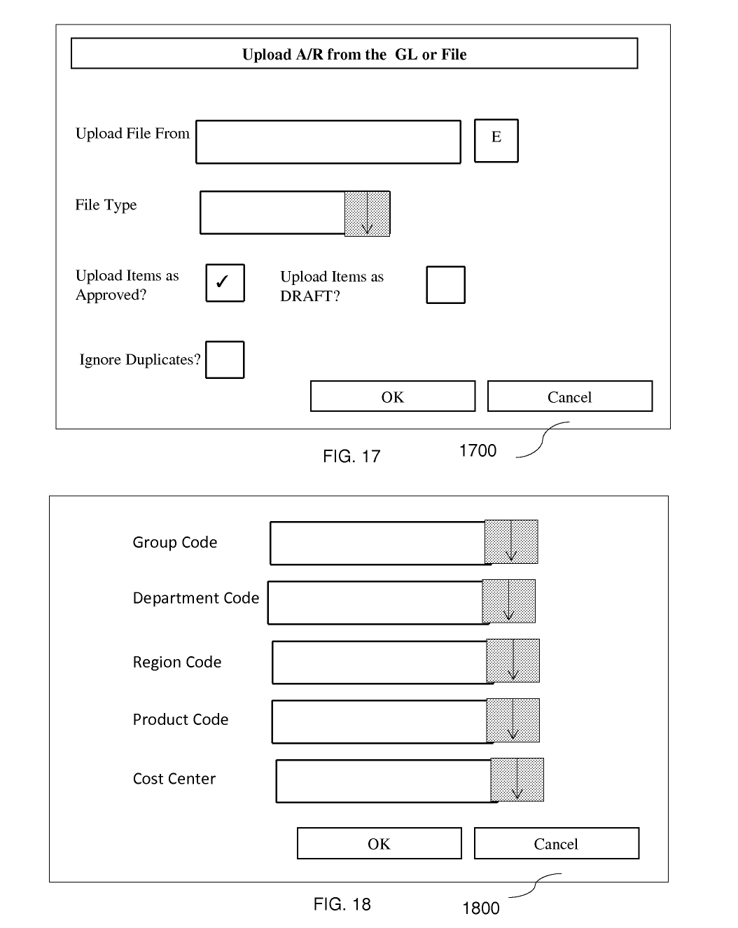

FIG. 17 shows an interface 1700 for uploading a file.

FIG. 18 shows an interface 1800 for setting codes.

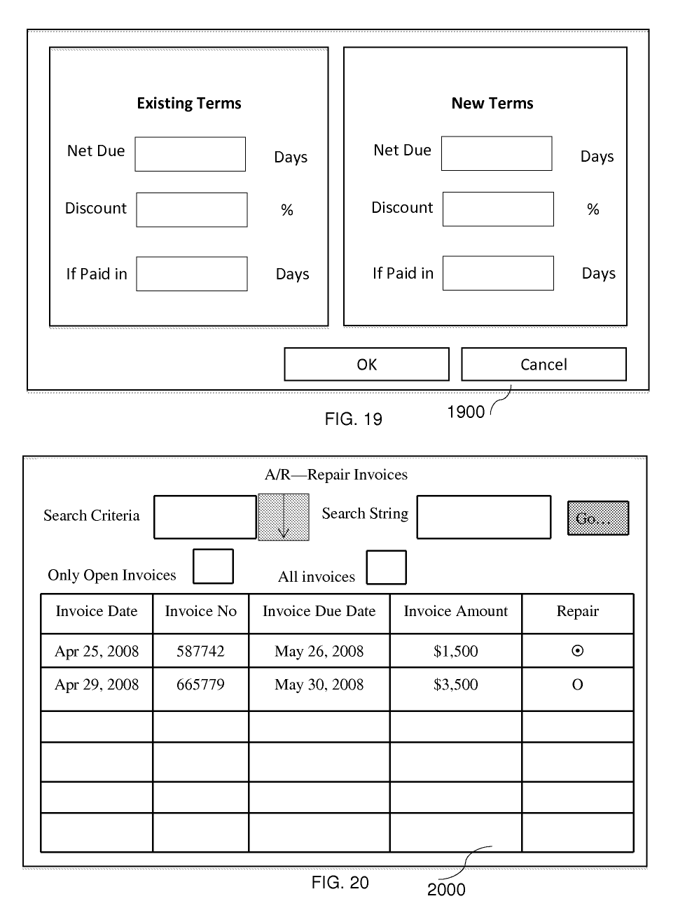

FIG. 19 shows an interface 1900 for changing terms.

FIG. 20 shows an interface 2000 for repair of invoices.

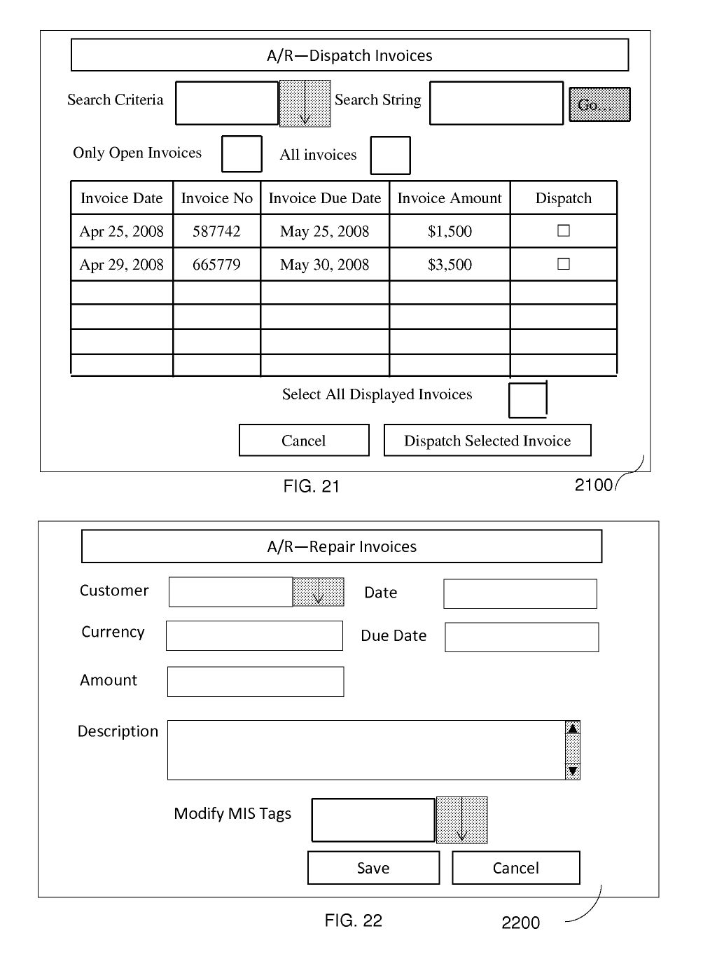

FIG. 21 shows an interface 2100 for dispatch of invoices.

FIG. 22 shows an interface 2200 for editing of invoices.

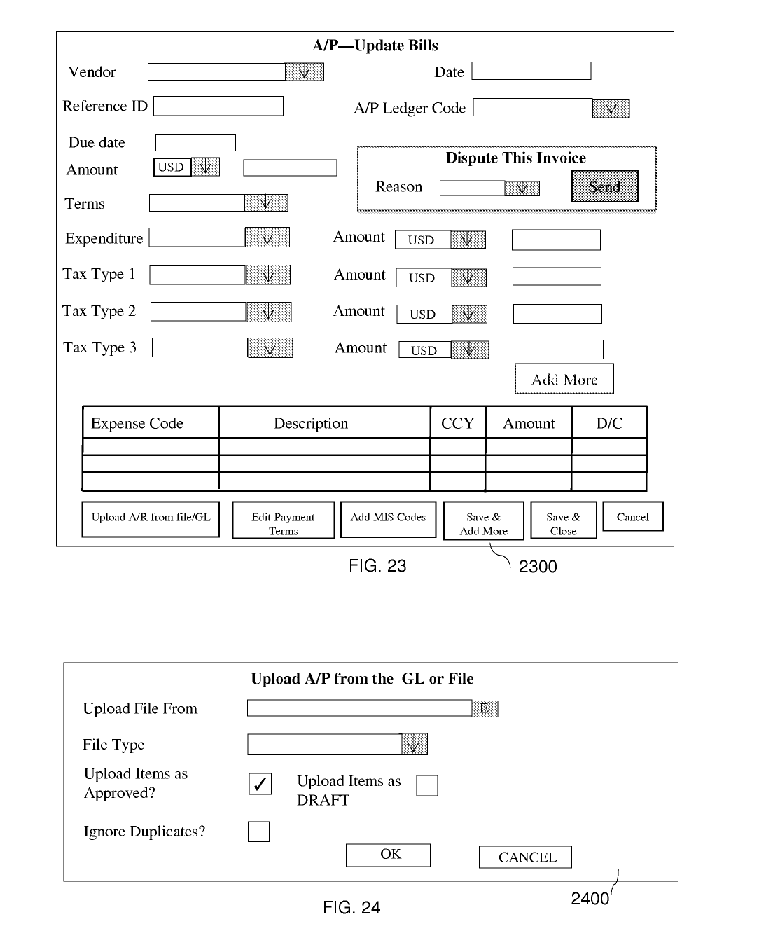

FIG. 23 shows an interface 2300 for AP Updating of bills. It provides options to create invoices by uploading a file from GL or by manually entering data. Data fields to comply to standard invoice parameters.

FIG. 24 shows an interface 2400 for adding an AR from GL.

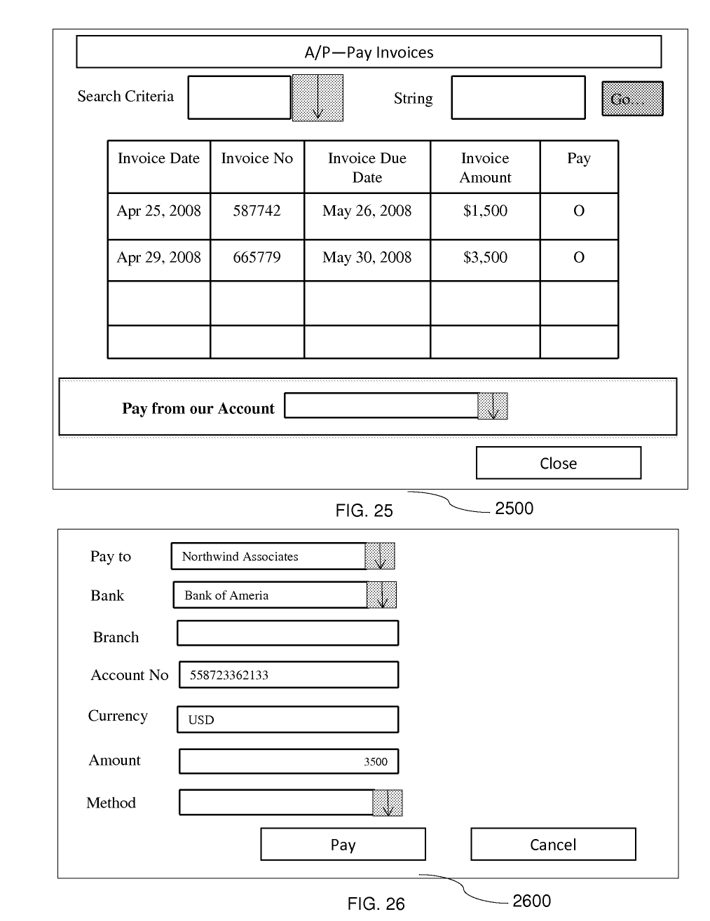

FIG. 25 shows an interface 2500 for Accounts Payables for Pay Invoice.

FIG. 26 shows an interface 2600 for payment.

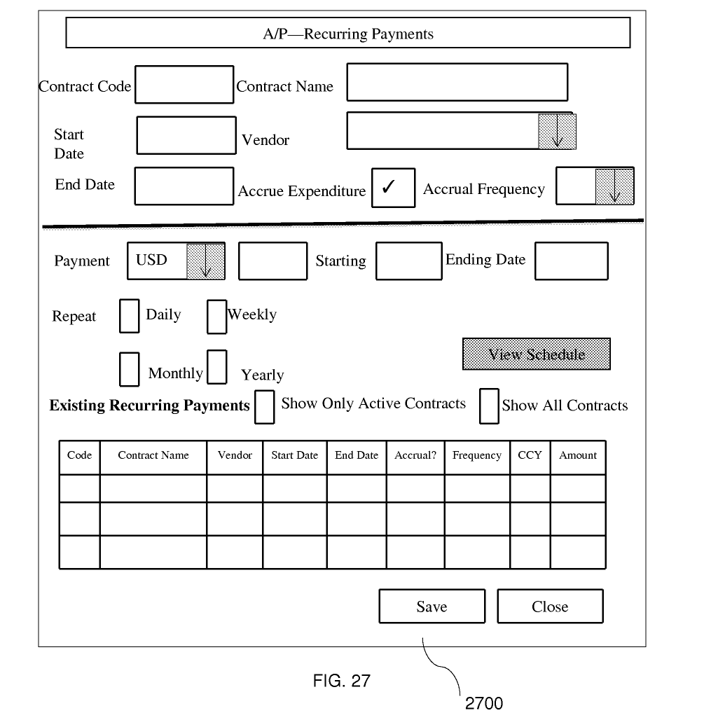

FIG. 27 shows an interface 2700 for AP Recurring Payments.

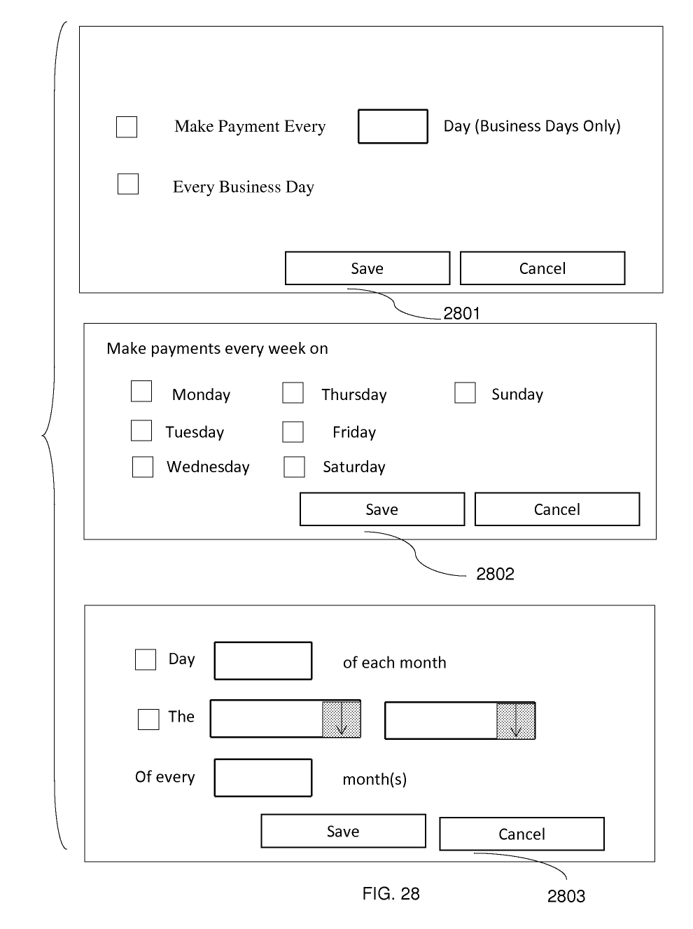

FIG. 28 shows interfaces 2801, 2802 and 2803 for recurring payments.

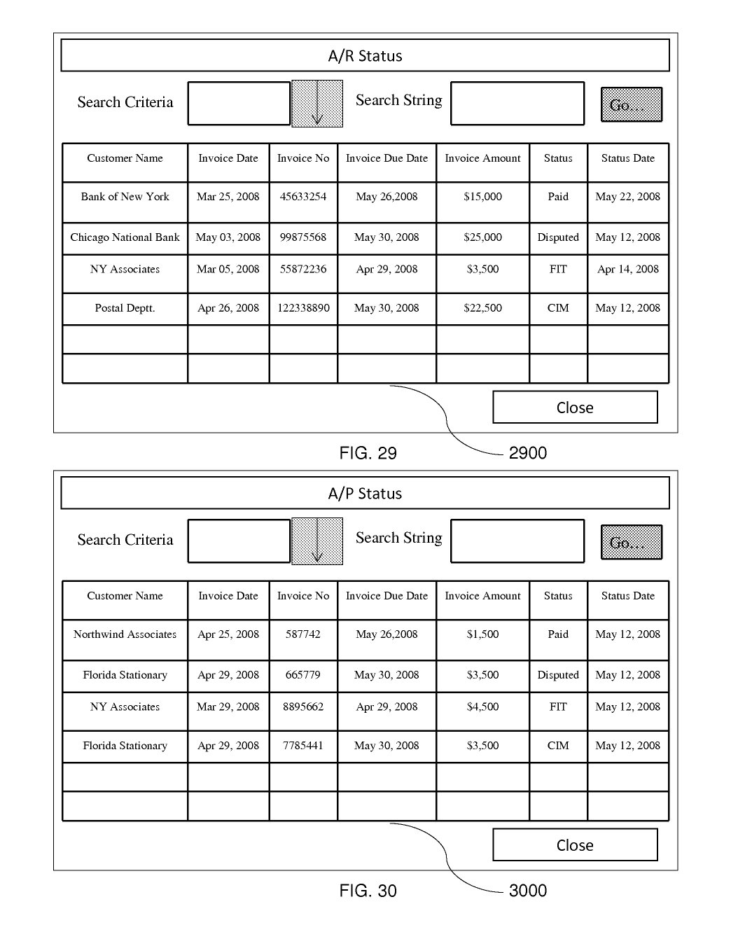

FIG. 29 shows an interface 2900 for Accounts Receivables Status.

FIG. 30 shows an interface 3000 for Accounts Payables Status.

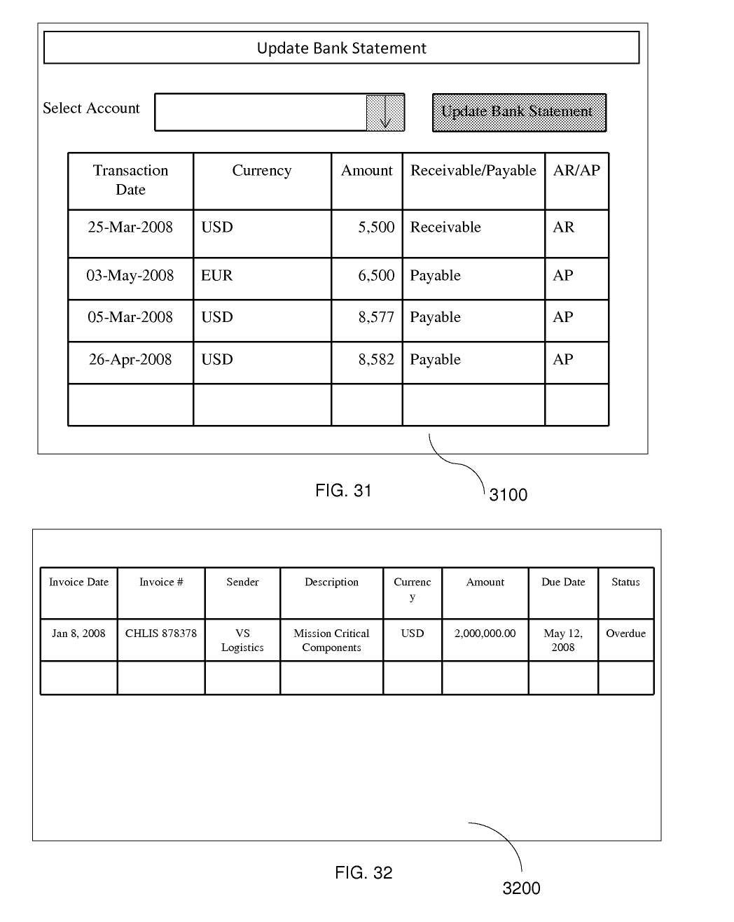

FIG. 31 shows an interface 3100 for an update bank statement.

FIG. 32 shows an interface 3200 for an invoice listing.

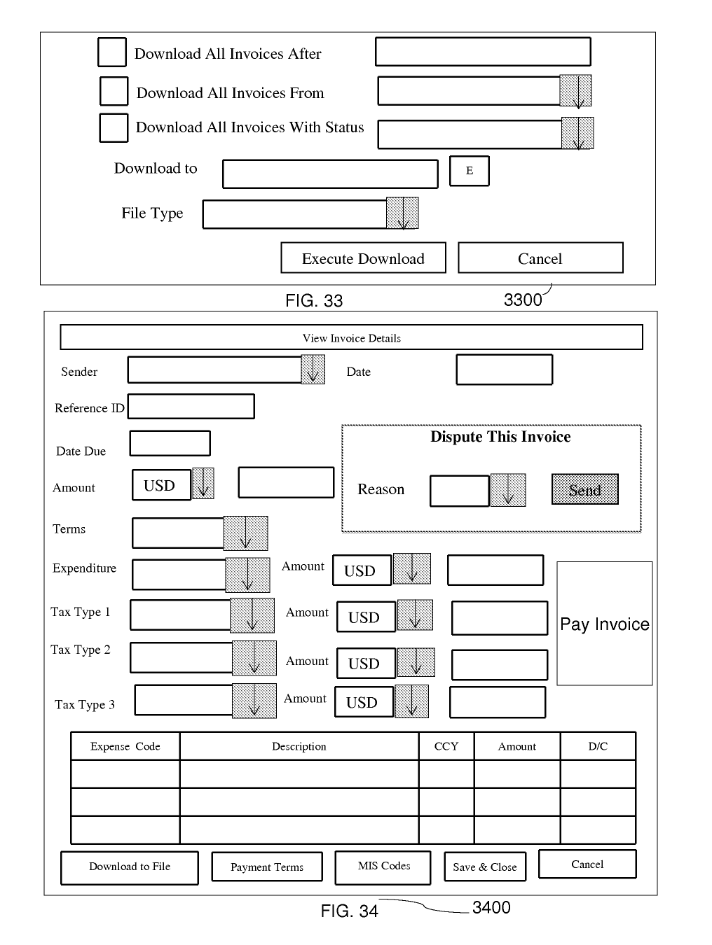

FIG. 33 shows an interface 3300 for an invoice download.

FIG. 34 shows an interface 3400 for an external view and provides options to create invoices by uploading a file from GL or by manually entering data.

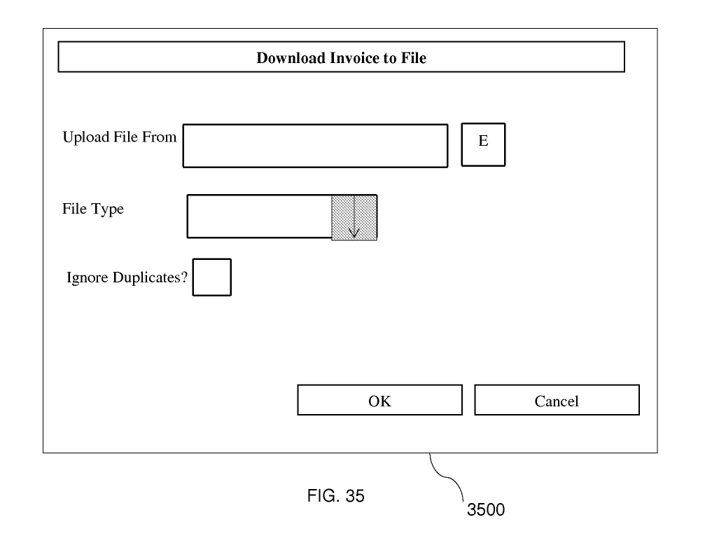

FIG. 35 shows an interface 3500 for invoice download.

In summary, a system and methods have been provided as an aspect of the present invention that transmit and collect authorized remittance information related to an invoice from initial issuance of the invoice until payment and receipt of payment. The system and methods which are provided as an aspect of the present invention are designed for an open user group, as means and methods are provided to accept and translate any invoice, message and transaction format that can be translated. The system and methods which are provided as an aspect of the present invention are flexible as they provide on-demand invoice processing, if required per invoice and an outsourced service of invoice processing as it may handle all or a significant part of a vendor's invoice processing. The system and methods which are provided as an aspect of the present invention allow a vendor and a payer to maintain existing banking relations.

While the foregoing is directed to embodiments of the present invention, other and further embodiments of the invention may be devised without departing from the basic scope thereof.

While there have been shown, described and pointed out, fundamental novel features of the invention as applied to preferred embodiments thereof, it will be understood that various omissions and substitutions and changes in the form and details of the system and methods illustrated and in its operation may be made by those skilled in the art without departing from the spirit of the invention. It is the intention, therefore, to be limited only as indicated by the scope of the claims appended hereto.

1. An invoice payment system for processing an invoice to effect payment thereof, comprising:
a controller system;
a vendor entity processing system;
a payer processing system;
a vendor bank;
a payer bank;
a partner bank; and
wherein the controller system communicates electronically with the vendor processing system, the payer processing systems and the partner bank to effect transfer of an amount of money related to the invoice from the payer bank to the vendor bank.

2. The invoice payment system as claimed in claim 1, wherein the controller system assigns a unique identifier to the invoice and associates the unique identifier with a plurality of transactions related to the invoice.

3. The invoice payment system as claimed in claim 2, wherein the controller system associates the unique identifier to one or more messages related to the invoice processed by the controller system and exchanged with one or more of the group consisting of the vendor entity processing system, the payer processing system, and the partner bank.

4. The invoice payment system as claimed in claim 1, wherein the invoice payment system is connected to a network.

5. The invoice payment system as claimed in claim 1, further comprising the instructions for:
transmitting the invoice from the vendor entity processing system to the controller system;
associating of a unique identifier to the invoice by the controller system; and
generating by the controller system of a message related to the invoice for the payer entity processing system.

6. The invoice payment system as claimed in claim 1, further comprising an instruction for:
generating by the payer entity processing system of a message for the controller system containing an instruction for the payer bank to pay an amount of money related to the invoice to the partner bank.

7. The invoice payment system as claimed in claim 6, further comprising an instruction for:
generating by the controller system of a message for the partner bank containing the instruction for the payer bank to pay an amount of money related to the invoice to the partner bank.

8. The invoice payment system as claimed in claim 7, further comprising an instruction for:
generating by the partner bank a message for the payer bank containing the instruction for the payer bank to pay an amount of money related to the invoice to the partner bank.

9. The invoice payment system as claimed in claim 1, further comprising an instruction for:
transferring by the payer bank an amount of money related to the invoice to the partner bank.

10. The invoice payment system as claimed in claim 9, further comprising an instruction for:
sending by the payer bank a message to the partner bank confirming transferring of an amount of money related to the invoice.

11. The invoice payment system as claimed in claim 1, further comprising an instruction for:
transferring by the partner bank to the vendor bank an amount of money related to the invoice.

12. The invoice payment system as claimed in claim 1, further comprising an instruction for:
sending by the partner bank a message to the controller system related to transferring an amount of money related to the invoice to the vendor bank.

13. The invoice payment system as claimed in claim 1, further comprising an instruction for:
sending by the controller system to the vendor entity processing system a message related to transferring an amount of money related to the invoice to the vendor bank.

14. The invoice payment system as claimed in claim 1, further comprising an instruction for:
sending a message to the vendor entity processing system expressing an intention to pay an amount of money related to the invoice.

15. A method for processing of an invoice to effect payment thereof, comprising:
using a controller system, the controller system enabled to exchange messages related to the invoice with:
a vendor entity processing system;
a payer processing system;
a partner bank, the partner bank enabled to exchange a message with a payer bank and a vendor bank;
associating a unique identifier with the invoice and associating the unique identifier with a message related to the invoice; and
transferring an amount of money related to the invoice from the payer bank to the vendor bank as a result of the exchange of messages related to the invoice.

16. The method as claimed in claim 15, wherein the controller system associates the unique reference number with a plurality of transactions related to the invoice.

17. The method as claimed in claim 15, further comprising the steps of:
transmitting a message related to the invoice from the vendor entity processing system to the controller system;
transmitting by the invoice processing system a message for the payer entity processing system related to the invoice;
transmitting by the payer entity processing system a message to the controller system, the message containing an instruction for the payer bank to pay an amount of money related to the invoice to the partner bank.

18. The method as claimed in claim 16, further comprising a step of:
transmitting by the controller system a message to the partner bank containing an instruction for the payer bank to pay an amount of money related to the invoice to the partner bank.

19. The method as claimed in claim 18, further comprising a step of:
transmitting by the partner bank a message to the payer bank containing an instruction for the payer bank to pay an amount of money related to the invoice to the partner bank.

20. The method as claimed in claim 19, further comprising the steps of:
transferring by the payer bank an amount of money related to the invoice to the partner bank;
transferring by the partner bank to the vendor bank an amount of money related to the invoice; and
sending by the partner bank to the controller system a message related to the transferring of money to the vendor bank related to the invoice.

21. The method as claimed in claim 21, further comprising a step of:
sending by the controller system to the vendor entity processing system a message related to the transferring of money related to the invoice to the vendor bank.

22. The method as claimed in claim 15, further comprising using a profile unit, the profile unit comprising a profile of a payer.

23. The method as claimed in claim 15, comprising using a visibility engine, the visibility engine providing a report on a status of processing the invoice.

24. The method as claimed in claim 16, comprising using a forecasting engine for forecasting a cash flow status related to a payment of the invoice.
